(19) United States
(12) Patent Application Publication
(10) Pub. No.: US 2012/0187649 A1
(43) Pub. Date: Jul. 26, 2012

(54) Rowing-Motion Propelled Wheelchair Generating Power from Rowing Motion in Both Directions

(76) Inventors: Christopher J. Bayne, Los Gatos, CA (US); Stephen Barker, Sheridan, OR (US)

(21) Appl. No.: 13/263,683

(22) PCT Filed: Apr. 7, 2010
(86) PCT No.: PCT/US10/30308

§ 371 Date: Apr. 9, 2012

Related U.S. Application Data
(60) Provisional application No. 61/202,802, filed on Apr. 7, 2009.

(30) Foreign Application Priority Data
Sep. 8, 2009 (US) 12/555239

(51) Int. Cl. A61G 5/02

(52) U.S. Cl. 280/242.1

(57) ABSTRACT

The present invention solves many of the problems for the wheelchair bound individual who wants an ergonomically sensible, convenient, yet powerful and stable wheelchair. The Trike's unique power source is provided by a rowing-type motion of the user rather than the less efficient “hand rim” grip or wrist propulsion. Power is generated both in the out rowing stroke and the in rowing stroke through a inventive power drive. The rowing motion significantly reduces the chances for repetitive stress injuries, like carpal tunnel. Furthermore, the rowing motion and movements are designed to facilitate efficient propulsion and steering in combination, to be effected simultaneously. The rowing motion allows the user's full arm strength and full range of motion to assist in the powering of the vehicle.

### REFERENCE TO PRIORITY DOCUMENTS

This Application claims priority under 35 USC §119(e) to U.S. Provisional Application 61/202,802, filed Apr. 7, 2009 entitled “Rowing-motion Propelled Wheelchair Generating Power from Rowing Motions in Both Directions,” which is incorporated by reference for all purposes. This application also claims priority to U.S. application Ser. No. 12/555,239, filed Sep. 8, 2009, which is also incorporated by reference for all purposes.

### BACKGROUND

Many of the existing hand-propelled wheelchairs designed for improved power efficiency do not account for certain repetitive motion injuries that are particularly problematic for the wheelchair-bound population. While power may be the focus of these devices, the potential damage to even the most hearty of those who use such devices is catastrophic to the mobility of the wheelchair-bound, should injuries even as innocuous as tendonitis. Such injuries are often overlooked in wheelchair design, because they are not so devastating to the mobility of an able-bodied person.

Furthermore, wheelchairs designed for high-speed use, may not account for the day-to-day needs of the wheelchair-bound individual either with regard to comfort, ease of use, or maneuverability in small spaces such as restrooms, common carriers, and commercial offices. Thus, generally the more rugged or powerful the wheelchair, the less appropriate it is for convenient everyday use. Other vehicles, such as U.S. Pat. No. 6,352,274 (which is incorporated by reference for all purposes) to Brian Redman may be designed for certain-aspects of human-powered mechanical efficiency, but do not address the needs of the disabled, such as use in a confined space, and are therefore not appropriate for adaptation for use in a wheelchair.

A regular wheelchair with only “hand rim” propulsion provides no mechanical advantage (MA) and are therefore it is hard work to propel long distances, and especially difficult up hill. It is also has the disadvantage that power is interrupted and energy is wasted every time the hand rim is gripped and released because the mechanism is not continuous. For many wheelchair users, to propel over long distances can be strenuous and stressful on the shoulders and wrists. Hand cycles are limited mainly to outdoor use because they lack maneuverability.

### SUMMARY OF THE INVENTION

The present invention, in certain embodiments call by its trade name, the TRIKE™, solves many of the problems for the wheelchair bound individual who wants an ergonomically sensible, convenient, yet powerful and stable wheelchair. The Trike's unique power source is provided by a rowing-type motion of the user rather than the less efficient “hand rim” grip or wrist propulsion. The rowing motion significantly reduces the chances for repetitive stress injuries, like carpal tunnel. Furthermore, the rowing motion and rowing movements, are designed to facilitate efficient propulsion and steering in combination, to be effected simultaneously. The rowing motion allows the user's full arm strength and various range(s) of motion to assist in the powering of the vehicle. Other advantages of the present invention are included in table 1 below:

TABLE 1
Main Features and Benefits summary of the “Trike”
in a first embodiment

| Feature | Benefit |
|---|---|
| Transformable | Versatility for road and indoors (5 ft turning radius |
| | in cycle mode/360° on the spot rotation in |
| | wheelchair mode) |
| Mechanical | Increased propulsion, power or speed compared to |
| Advantage | “Hand Cranking” or inverted peddle cycle. |
| Biomechanical | Rowing action capitalizes upon the increased range |
| Efficiency | of motion and ability of the whole upper body to |
| | deliver power as well as pulling and pushing. |
| Tilting | Maintains low center of gravity (C of G) for |
| Suspension | cornering, 20″ Seat Height for ease of transfer |
| | and safety, comfort springing |
| Quality | The highest engineering standards and quality |
| | components are used to ensure maximum |
| | performance and reliability |
| Healthy | Reduced risk of stress related and/or repetitive |
| | injuries compared to “hand rim” propulsion |
| Manufacturing | In particular embodiments of the invention, |
| Simplicity | many parts may be supplied by bicycle and |
| | other vehicle component manufactures. |

The propulsion system of the present invention is only one of the many innovative features that allow the user to convert the vehicle from a high-performance tricycle with improved center of gravity to highly-versatile wheelchair for everyday use. For example, the TRIKE™ may be converted, on the fly, from a three-wheeled vehicle to a more conventional four-wheeled chair with the power (rowing) handle stored in the interior of the chair with a retractable third wheel.

The “Trike” uses a rowing type action which is bio-mechanically better and does provide significant Mechanical Advantage (see calculations below). It also has a cyclical mechanism which lends itself to gearing. Cyclical mechanisms are “low impact” and therefore reduced risk of injury to joints and ligaments.

A first embodiment of the present invention is a hand propelled vehicle which quickly and easily “transforms” from TriCycle Mode (extended) into Wheelchair Mode (retracted). It also provides a significant “mechanical advantage” which means that the rider can enjoy traveling quickly and easily over considerable distances. Then upon reaching their destination and while remaining comfortably seated, can convert to wheelchair mode for the essential maneuverability inside a building, restroom, office or home “Trike” performs these functions all in the same vehicle with no need to transfer.

Another embodiment of the present invention using a retractable propulsion mechanism in the form of a collapsible T-bar, that will fit under the riding seat during the use of chair in a closed space.

Although the present invention retains the “hand rim propulsion” as a secondary means of propulsion because of its maneuverability in confined spaces, its primary motive power is provided by the rider with a “rowing motion” with what's called the “Power Steering” assembly. The “rowing motion” is a more natural and is bio-mechanically more efficient, regardless of the rider's size and strength. The other big advantage of the rowing style is the “range of motion” which lends itself ideally to exploitation of mechanical advantage afforded by the basic simple lever principle

The present invention has suspension that “tilts” into the corners, like a regular bicycle. This means that unlike a “tricycle” the rear wheels remain parallel, reducing rolling resistance and tire wear. The tilting suspension also means that stability is maintained at the regular seat height of 20″ which facilitates ease of “transfer” and increased visibility for and of the rider.

The present invention may be used for exercise to maintain cardiovascular fitness which is essential to good health and well being and is particularly important for wheelchair users, since a user is able to combine exercise with the mobility needs. For this reason the present invention combines the bio-mechanical efficiency with simple mechanical advantage resulting in easier propulsion with versatility and practicality to provide the rider with fun, exercise and convenience combined.

Embodiments of present invention may be configured to different end uses in various models will become available to suit many different types of users. For example, for the rider who wants the “Deluxe” version there may be a 7-speed (or higher) speed gearing and all the optional extras included; for the everyday user the “Standard” version is made without gearing and reasonably light weight; for the enthusiast, who just wants to go very fast, the light weight model which does not transform to “wheelchair configuration”.

### BRIEF DESCRIPTION OF THE DRAWINGS

FIG. 1A illustrates in the component systems of particular embodiments of the invention;

FIG. 1B illustrates the linear footprint of the retractable and extendible modes;

FIG. 1C illustrates the “rotational footprint” of the retractable and extendible modes;

FIG. 2A illustrates a first embodiment of the invention in extended mode from a side view;

FIG. 2B illustrates a first embodiment of the invention in extended mode from a top view;

FIG. 2C illustrates a first embodiment of the invention in extended mode from an underside view;

FIG. 3A illustrates a first embodiment of the invention in extended mode from the front view;

FIG. 3B illustrates a first embodiment of the invention in extended mode from the rear view;

FIG. 4A illustrates a first embodiment of the invention in a retracted mode from a side view;

FIG. 4B illustrates a first embodiment of the invention in a retracted mode from a top view;

FIG. 4C illustrates a first embodiment of the invention in a retracted mode from a rear view;

FIG. 5A illustrates the details of a propulsion system;

FIG. 5B illustrates magnified details of the propulsion system;

FIG. 5C illustrates the details of the propulsion system or drive from the underside;

FIG. 6A illustrates features of the suspension system of an embodiment of the hand-propelled vehicle from a rear view;

FIG. 6B illustrates optional features of the suspension system of a first embodiment;

FIG. 6C illustrates the features of the suspension system from a front angled view;

FIG. 6D, illustrates the principle of the tilting independent suspension for each wheel in a sample embodiment;

FIG. 7A illustrates the detail of the differential gear and axle features for a first embodiment from a rear view;

FIG. 7B illustrates the detail of the differential gear and axle features for a first embodiment from a angled view;

FIG. 8A illustrates the alternate drive principle;

FIG. 8B is an alternate view of the alternate drive principle;

FIG. 9A is a detailed view the differential system;

FIG. 9B is a close up of the differential system;

FIG. 10A is an illustration of an alternate embodiment of the invention;

FIG. 10B is a solid model of the alternate embodiment of the invention;

FIG. 11 is an illustration of the alternate embodiment of the invention with a retracted propulsion lever;

FIG. 12A is an illustration of the steering system in the alternate embodiment;

FIG. 12B is a solid model of the steering system in the alternate embodiment;

FIG. 13A is a second alternate embodiment;

FIG. 13B is a reverse view of the second alternate embodiment;

FIG. 14A is a alternate steering system for the second alternate embodiment;

FIG. 14B is a solid model of the alternate steering system.

FIGS. 15A-J are details of a second alternate embodiment of the invention.

### DETAILED DESCRIPTION OF THE DRAWINGS

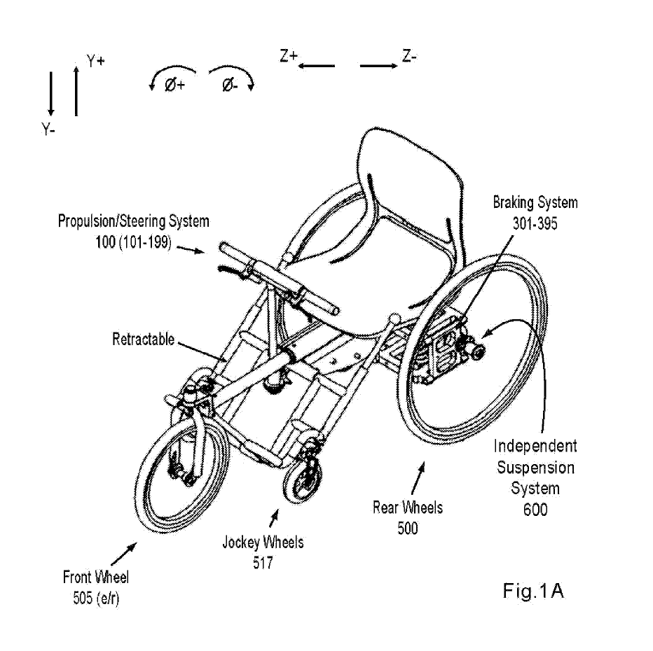

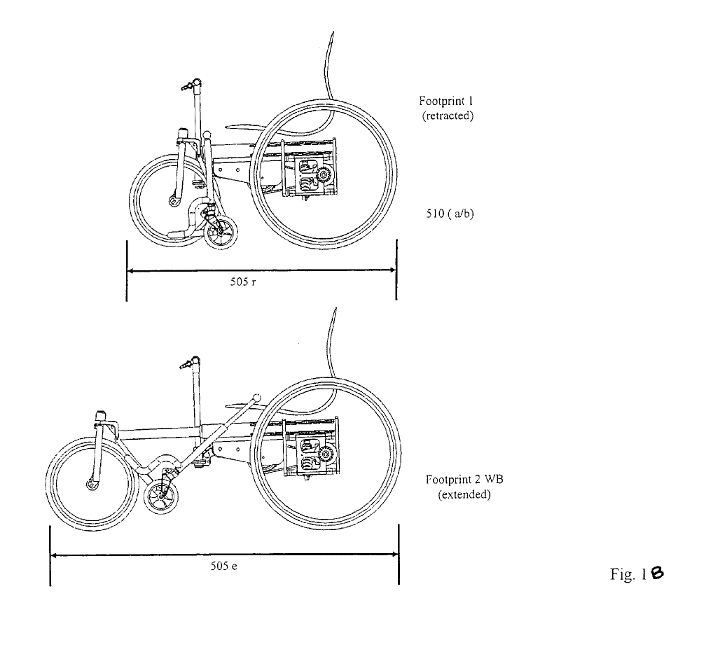

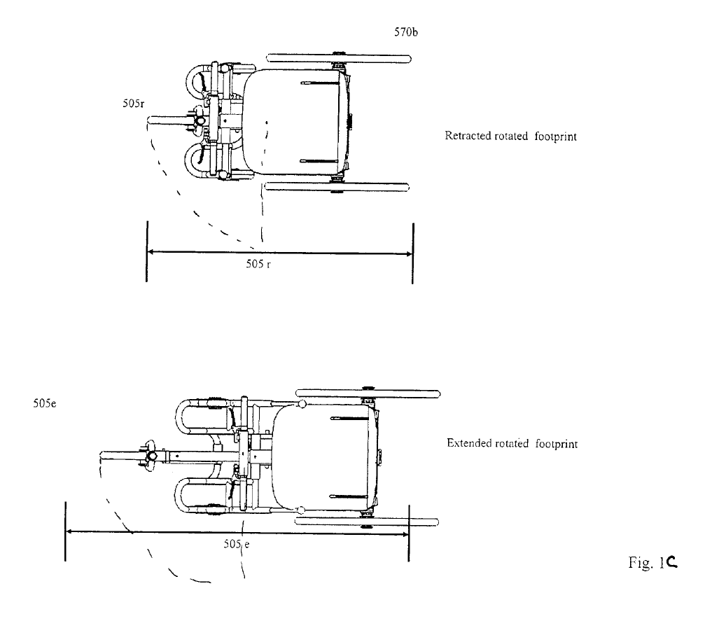

FIGS. 1A and 1B illustrate general conceptual groups of the components systems of several configurations of the present invention as it may be understood in terms of “systems.”

### I. Propulsion System 100 (Indices 101-199)

| Part title/description | Reference No. |
|---|---|
| Handlebar | 113 |
| T-bar | 112 |
| First Prop Elbow | 115 |
| Second Prop Elbow | 117 |
| Gear System | 101 (see FIG. 5a-5c) |
| Protective Gear | 998 |
| Covers | |
| 1^{st} Gear | 120 |
| First Axle | 120(ax) |
| Drive Chain 1 | 122 |
| (connects gears 1-2) | |
| Drive Chain 2 | 124 |
| (Connects gears 1-3) | |
| Drive Chain 3 | 126 |
| (connects gears 2-3 | |
| Gear | 130 |
| Second Axle | 130(ax) |
| Main Gearing (7- | 140 |
| speed hub gear) | |
| Output sprocket | 145 |
| Drive Chain | 155 |
| Differential Gear | 160a/b |
| II. Frame and | 200 (201-299) |
| retractable telescope | |
| and supports | |
| IIA. Telescoping tube | 230 |
| Inner telescoping part | 230(i) |
| Outer telescoping part | 230(o) |
| Locking pin | 232 |
| IIB. Frames from | 235 |
| retractable wheels | |
| Jockey H frame | |
| Jockey H frame foot | 235(fr) |
| rest 235 | |
| III. Steering and | 300 (301-399) |
| Braking systems | |
| IIIA: Steering | 301-349 |
| Cable | 301 |
| Steering knuckle | 302 |
| Cable Guide | 305 |
| Steering halo | 307 |
| Cable guide | 305 |
| IIIB Braking | 350-399 |
| Braking handle | 351 |
| Bearing brakes | 355 |
| Braking cable (not | 353 |
| shown) | |
| IV Seat and sitting | 400 (indices 401-499); |
| features | |
| V. Wheels | 500 (indices 501-599) |
| Front wheel extended | 505(e) |
| Front wheel retracted | 505(r) |
| Front wheel axle | 505(ax) |
| Rear wheels | 510(a/b) |
| Rear wheel axles | 510(a)(ax)/510(b)(ax) |
| Quick-release hubs | 512(a/b) |
| Drive shafts) | 515(a/b) |
| Jockey wheels and | 597(a/b) |
| brackets | 595 (a/b) |
| VI Shocks and | 600 (indices 601-699) |
| Suspension | |
| Shocks | 620 |
| Independent | |
| suspension a frame | 602/605(a/b) |

Each one of the “systems” includes features that may be understood by skilled artisans to have its own innovative implementations that are independent of embodiments of the hand-propelled vehicle as a whole. Thus, skilled artisans should understand that not only does the TRIKE™ contain innovative features as a whole, but includes innovative components and configurations that may be applied to other human-powered vehicles or even partially human-powered vehicles. For example, the telescoping support frame may be thought of as an invention that may be applied to conventional wheelchairs as well as the hand-propelled vehicles discussed herein.

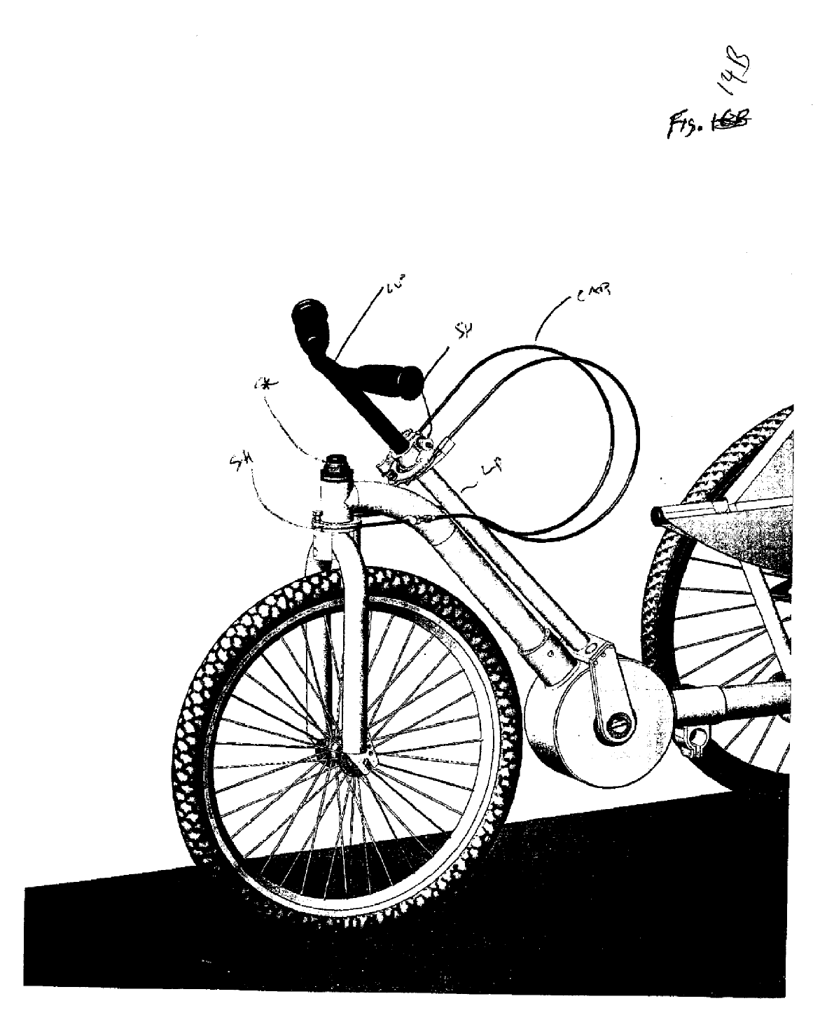

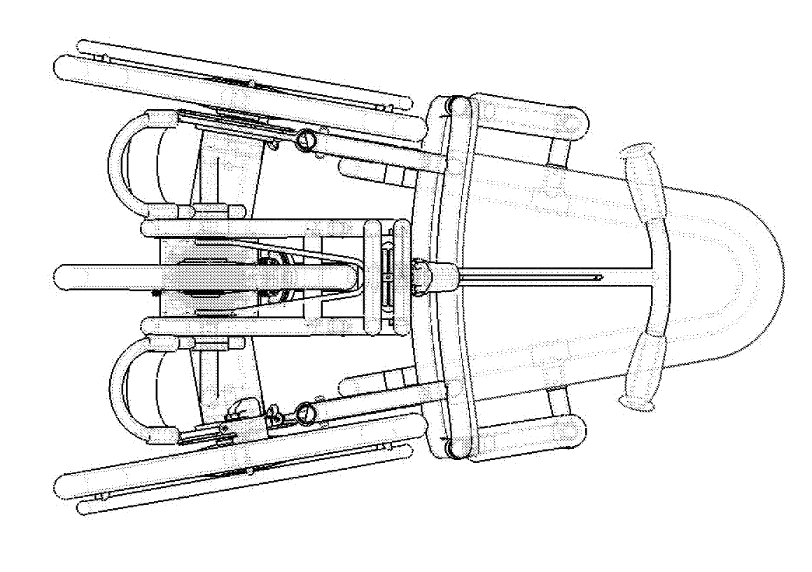

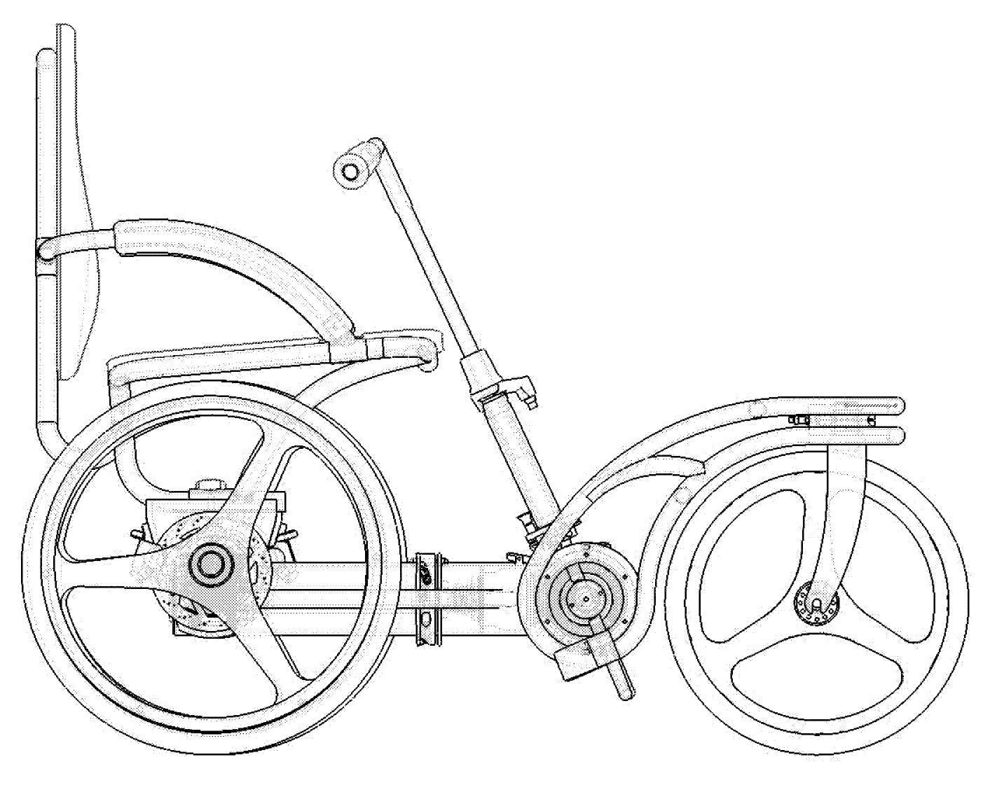

FIG. 1B illustrates the benefit of the retractable and extension feature of the hand-propelled vehicle from a linear or “wheelbase” perspective. Although, once again, the retractable/extendible feature should be thought of as both part of the hand-propelled vehicle and as an application that may be applied to conventional wheelchairs as well. FIG. 10 illustrates the advantage of having the “rotational” footprint, as wheelchairs need to operate in three-dimensional space, and the ability of a wheelchair user to reduce the rotational footprint in a small space by converting from the extended “travel” mode to the indoor “retracted” mode provides for a great degree of versatility for the wheelchair bound individual.

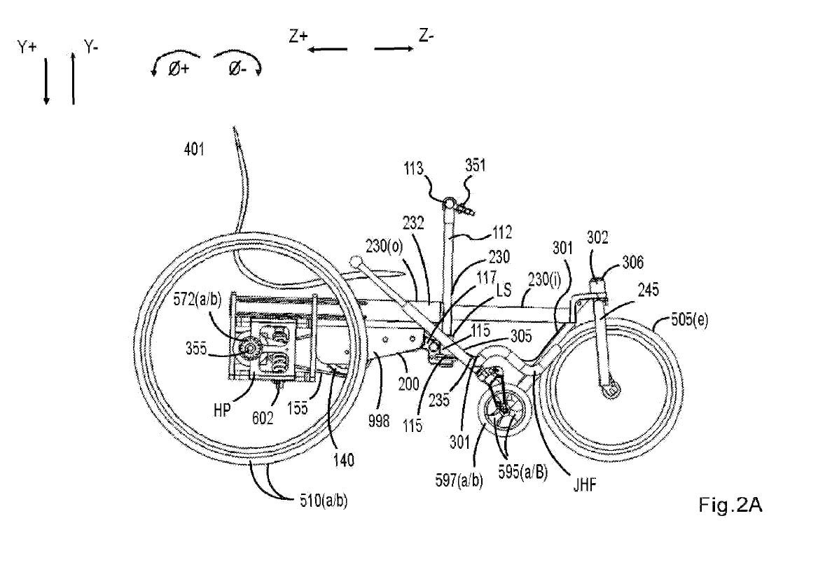

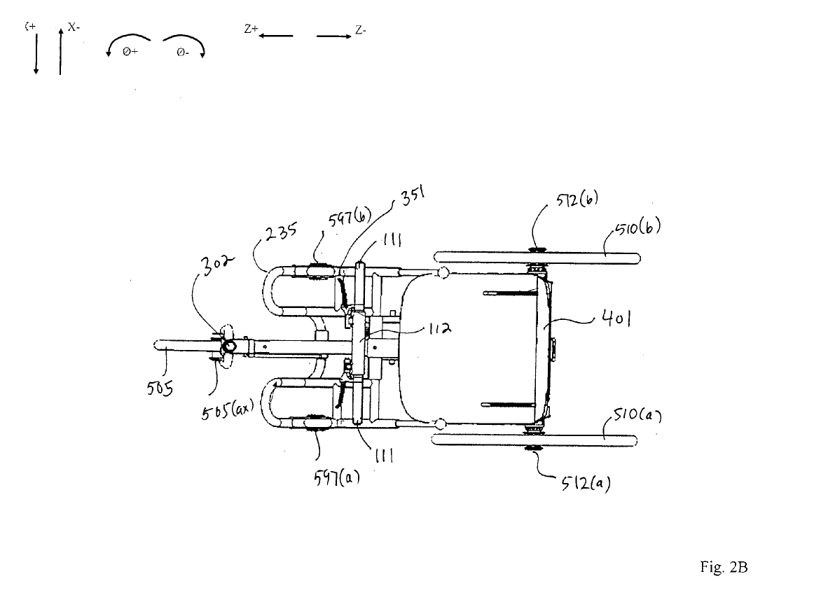

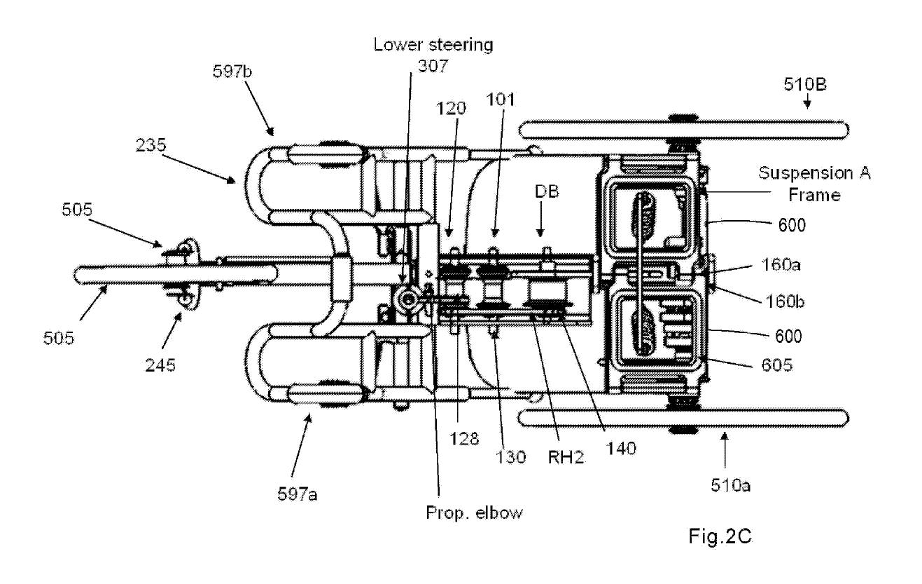

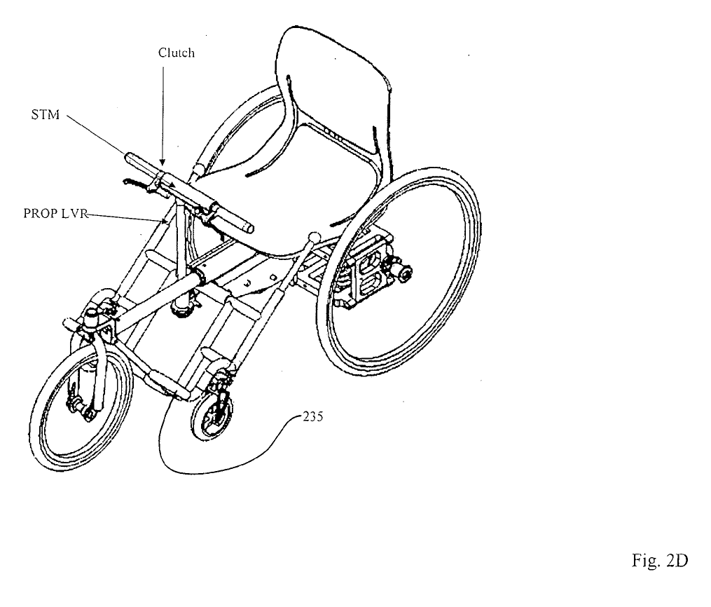

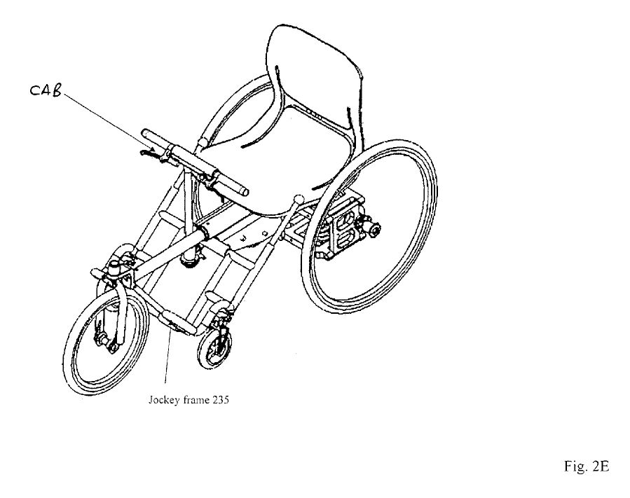

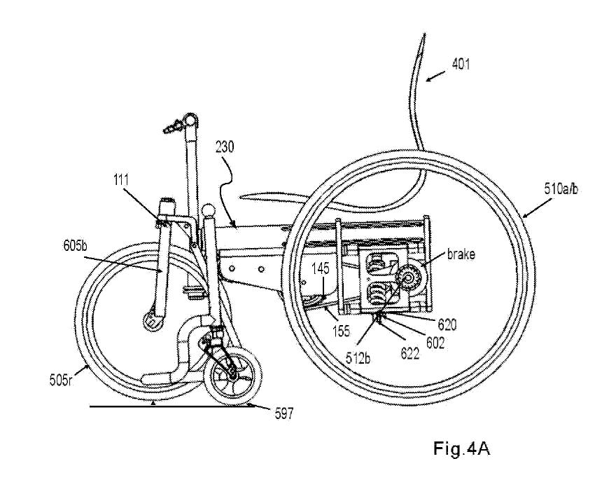

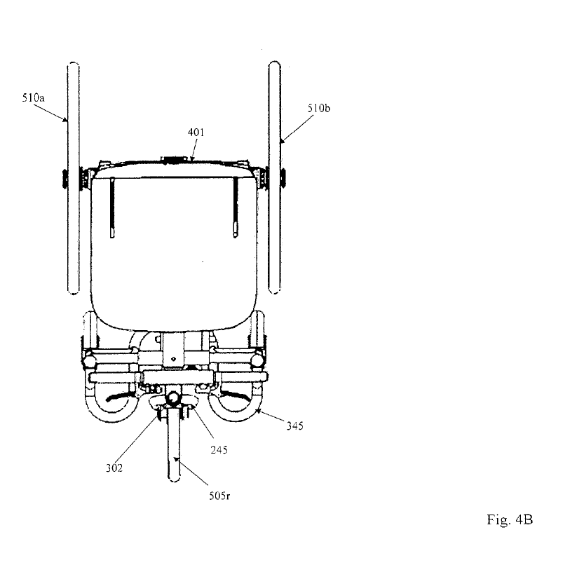

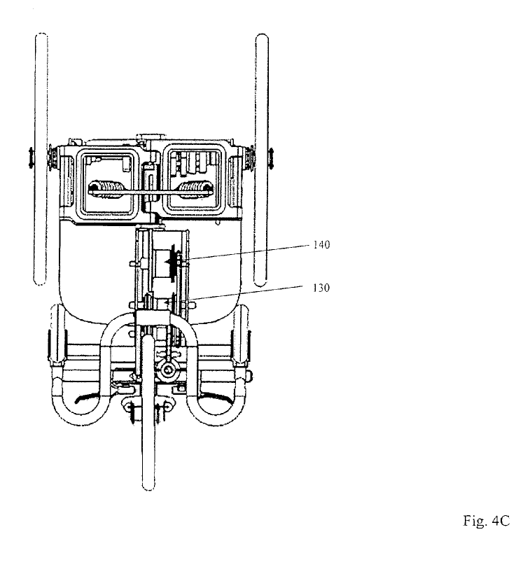

Referring now to FIGS. 2A-2C, side, top and underside views of the ‘extended’ mode of a first embodiment of the invention are shown. FIGS. 2a-2c illustrate the first embodiment from side, top and underside views respectively in an “extended” mode. The “retracted” mode of the first embodiment is shown in FIGS. 4a-5c below. The convertible hand-propelled wheelchair is supported on a frame system 200, of which the primary structure is a telescoping support tube or frame 230, that has an outer portion 230(o) and an inner portion 230(i), which is “lockable” in either an extended or retracted position by a pin 232, which can take a variety of securing structures without departing from the scope of the invention. The telescoping support tube 230, supports a jockey frame, or jockey H frame 235 is configured such that it supports the jockeys wheels (597(a)/b) when the hand-propelled vehicle is in a retracted mode, and allows the user to rest their feet comfortably the vehicle is in an extended position. The telescoping support tube 230 also provides structural support for the fifth wheel forks 245 which operatively support the front or fifth wheel 505(e) and its axle 505(ax).

FIGS. 2a-2c illustrate the innovative hand-propelled propulsion system 100 in the first embodiment. A handle bar 113, designed for easy gripping moves a “t-bar” or t-handle 112 propulsion lever or drive. The t-handle 112 moves forward and backward (indicated by z+ (front of the trike) and z− (rear of the trike)) with a slight arc (indicated by the theta+ or theta −,), but can vary based on the needs of the end user. The t-handle moves a first prop elbow 115, that also serves as a steering rotation around a plane. A cable (not shown) which extends from cable link structure 305 allows the t-handle 112 to turn the front wheel 505(e) at the steering knuckle 302. A two-way gear system 101 include a three gear configuration that allows the propulsion handle 112 to create forward motion by both the pushing and pulling motion.

FIG. 2b shows a top view of the extended first embodiment, illustrates how a user turns the handle bars 113, so that the t-bar 112 is moved around an axis formed by the XZ plane(the rotations indicated by a phi(+) phi(−)) to steer the first embodiment of the hand-propelled. The cable guide 305 allows a standard bicycle cable to steer the fifth wheel 505(e).

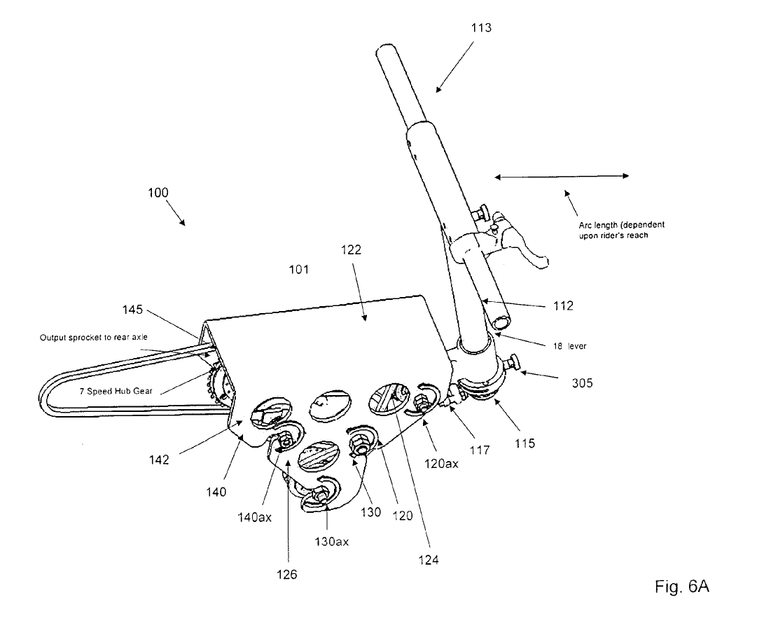

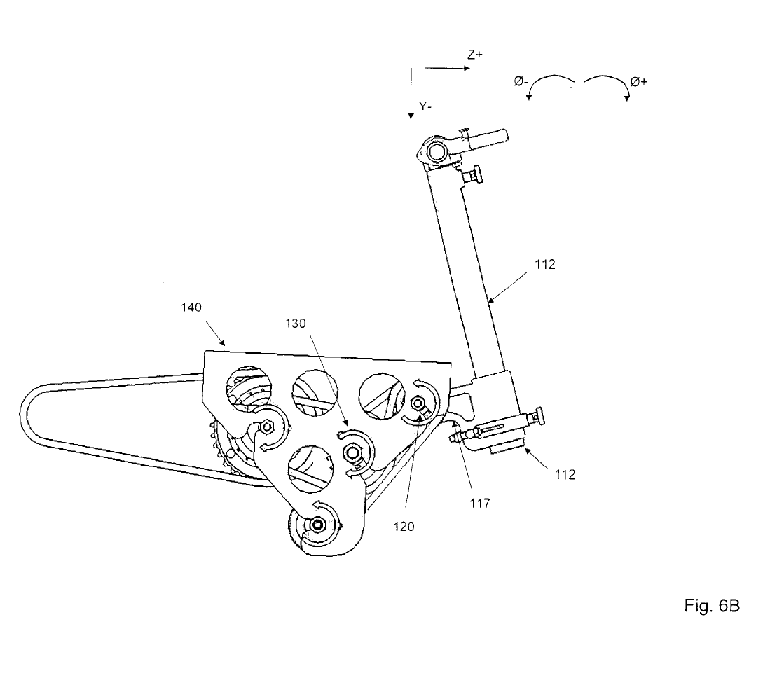

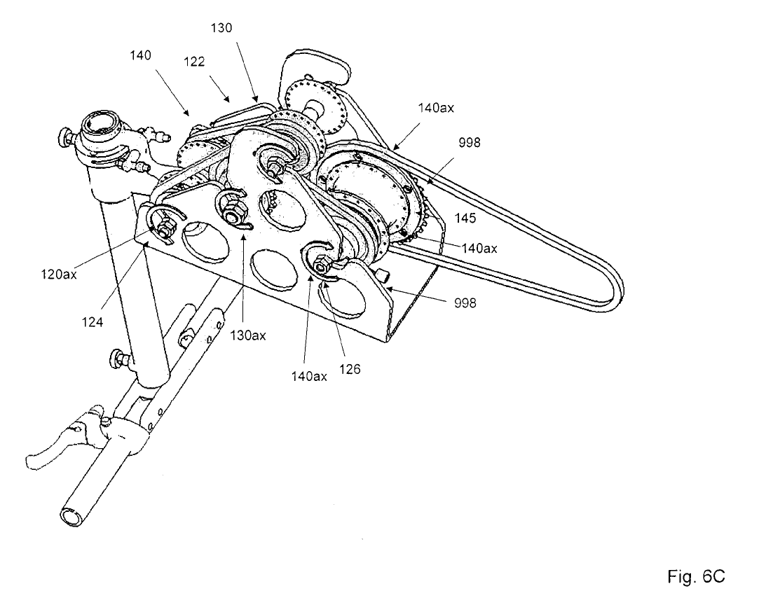

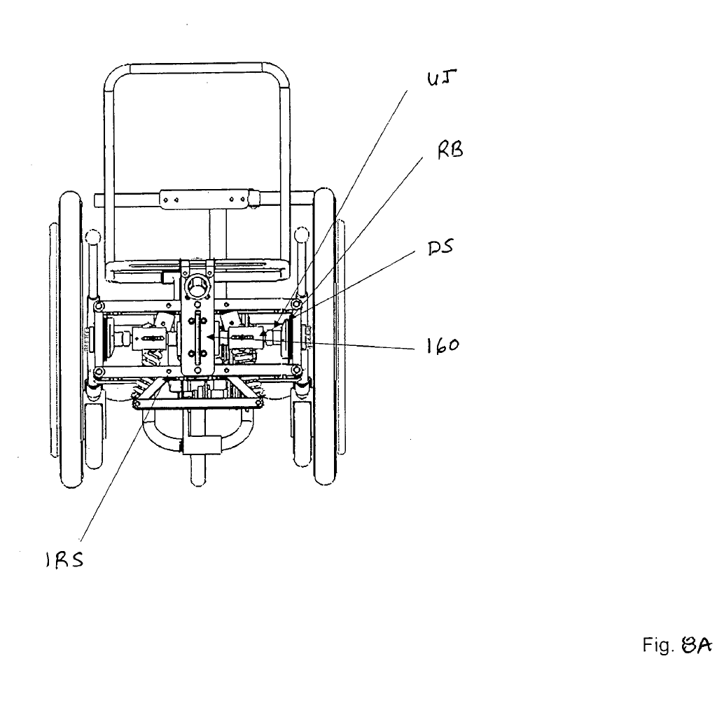

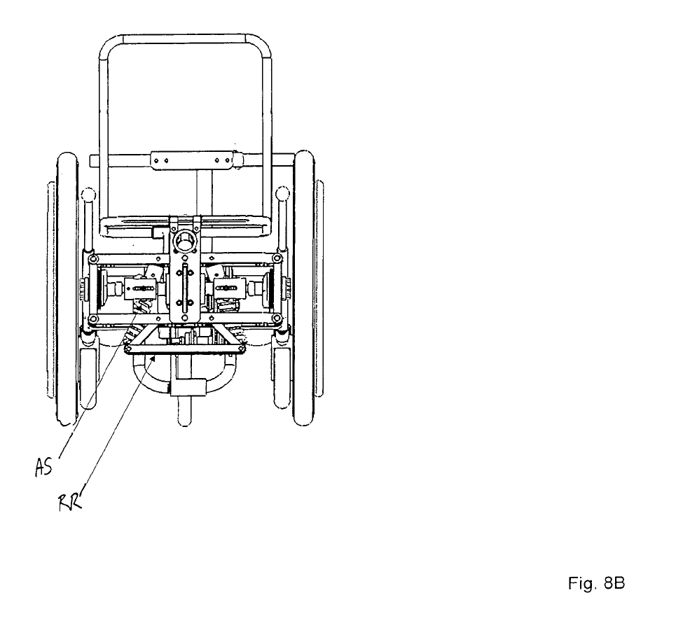

FIG. 2c illustrates the underside of the first embodiment, which more clearly details the gear system of the propulsion system 101. The second prop elbow 117 drives the first gear 120 when the propulsion handle 112 is moved both forward and backward. The propulsion system is discussed further in FIGS. 6a-d below. FIGS. 2d and 2e provide additional views of a first embodiment in an extended position.

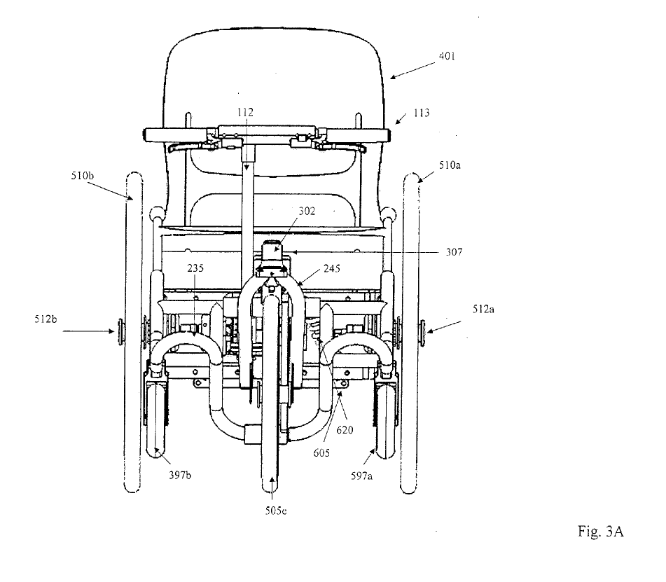

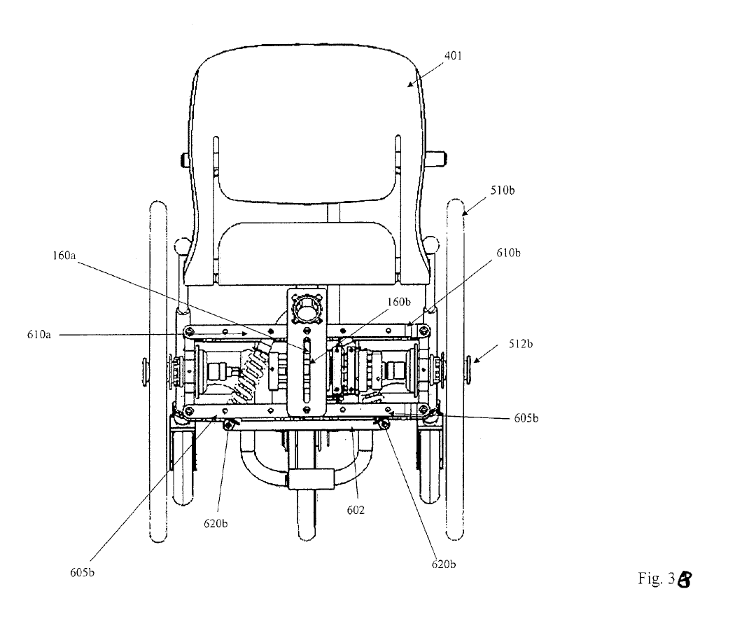

FIG. 3A provides a front view of a first embodiment in an extended position. In FIG. 3a, it is clear that the jockey wheels 597(a/b) are off the surface of the ground a few inches. Additionally the steering knuckle 302 for the fifth retractable wheel can be seen. There may be several mechanisms by which the TRIKE may be efficiently and safely turned along the fifth wheel pivot 307.

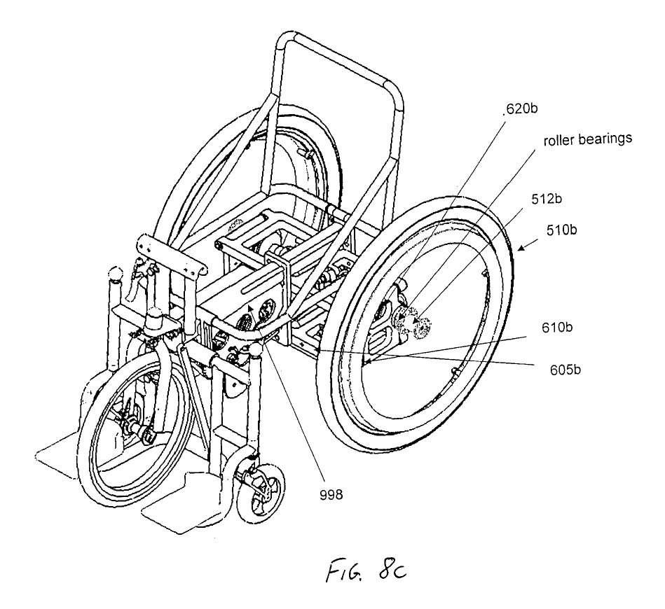

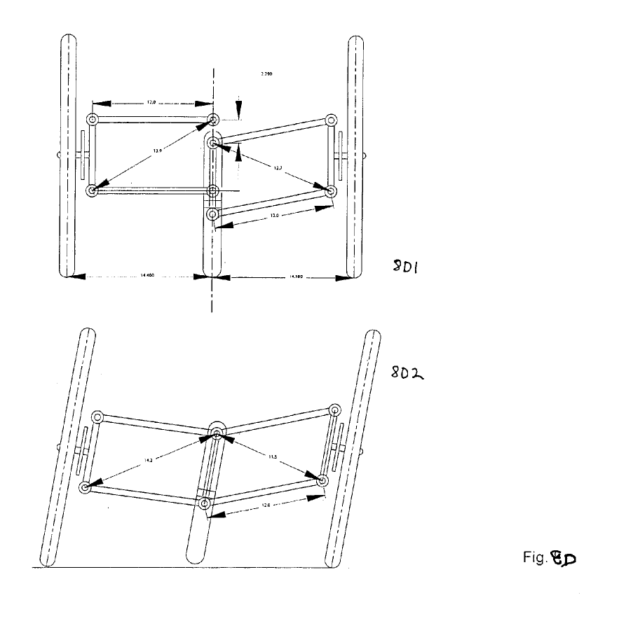

FIG. 3b provides a rear view of the first embodiment of the invention and many of the suspension and support features can be seen. The independent suspension system 600 and the differential gearing 160a/b allow for the hand-propelled vehicle to be safely used in high-performance racing and made with standardized parts. The shocks 620 also provide the rider with additional safety and comfort. The independent wheel suspension is also detailed in FIGS. 8a-d below.

FIG. 4a illustrates a first embodiment of the hand-propelled vehicle in a retracted mode. The jockey wheels 597(a/b)(down) touch the surface of the ground, and the fifth wheel is raised 505(r) a few inches off of the ground. The folding part 111 of the handlebar 113 folds into the t-bar 112, so that there is nothing in front of the wheelchair user. FIG. 4b illustrates a top view of the retracted mode of a first embodiment. FIG. 5A provides a front view of the retracted mode of the first embodiment and FIG. 5b provides a rear view of the retracted first embodiment.

Referring now to FIGS. 5a-5c, a propulsion or drive system 100 is shown in a first embodiment from top angle, side and underside views. The propulsion system 100 allows the TRIKE to be powered by the rider by moving the propulsion handle in both the forward rotation θ(+) and the reverse rotation θ(−). The “rotation” is not a pure circular “arc” but rather an ergonomically designed movement in both the x and y planes that will resemble a natural “rowing motion.” Although, in certain embodiments, pure linear (Z+/−) may be more desirable for certain aspects of physical therapy (such as arm or elbow rehabilitation) rather than ergonomic advantages. Thus, skilled artisans should understand that different motions of the hand-propulsion drive may be used without departing from the spirit and scope of the invention. The t-handle 112 drives the vehicle forward by moving the prop elbows 115/117 which move the free wheels on the first gear 120.

Using a combination of the LH and RH free wheels (shown as included in gear 120) and idler sprockets results in clockwise rotation of the axle irrespective of which direction the input lever is moving. The primary drive gear 140 drives the output sprocket 145 which is connected to the differential 160(a/b) by a drive chain, allowing the rear wheels to safely turn corners by moving at different speeds.

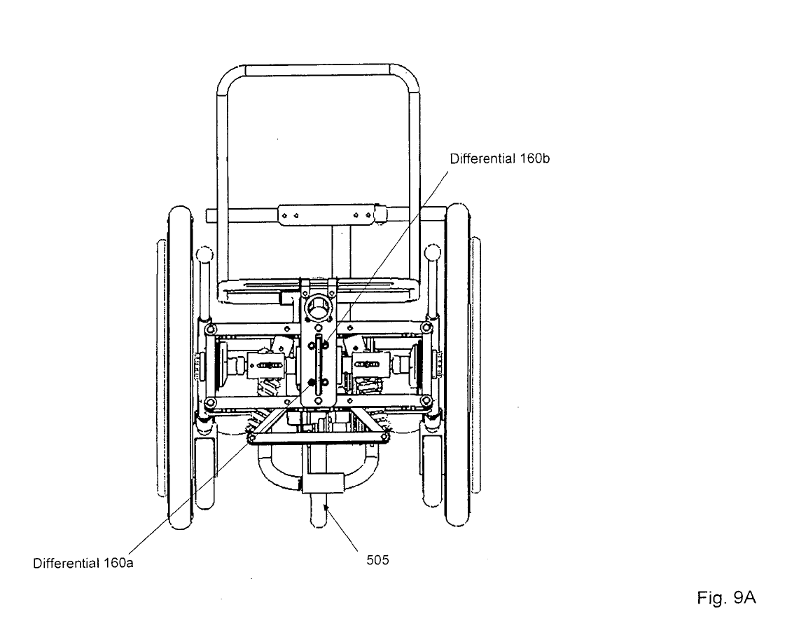

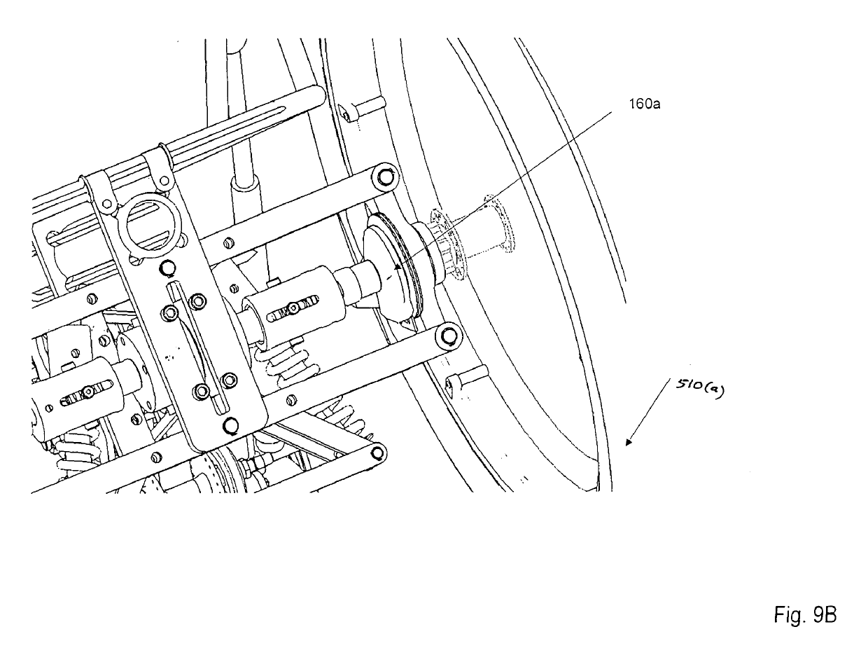

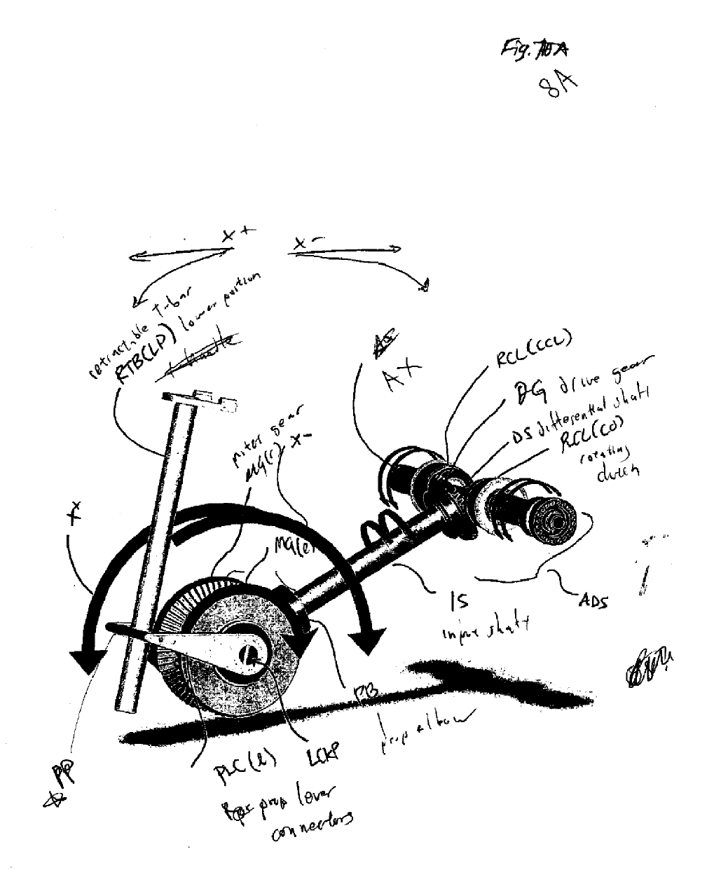

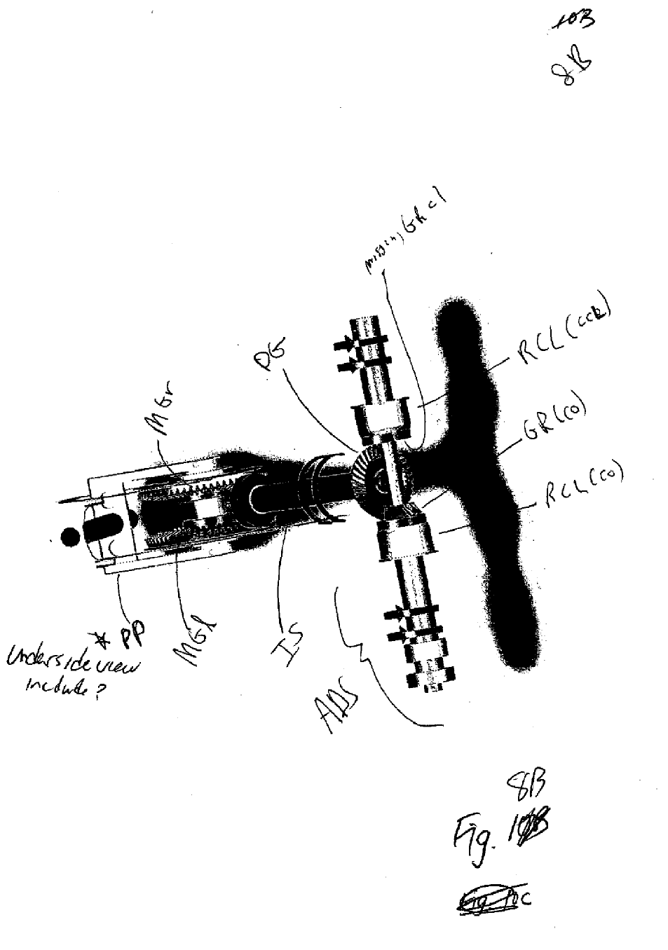

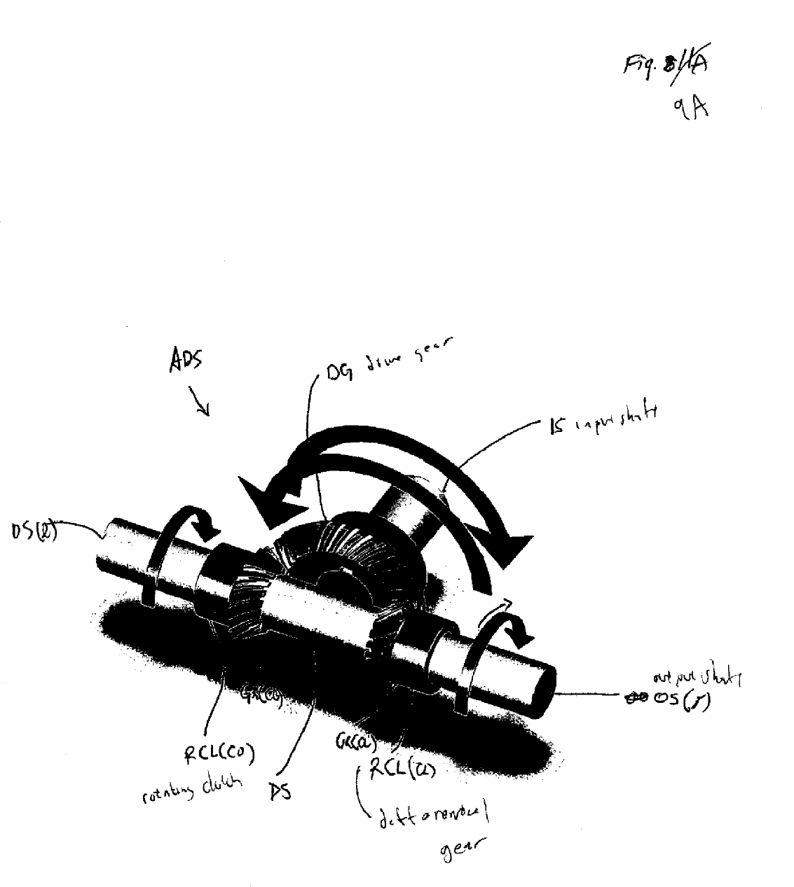

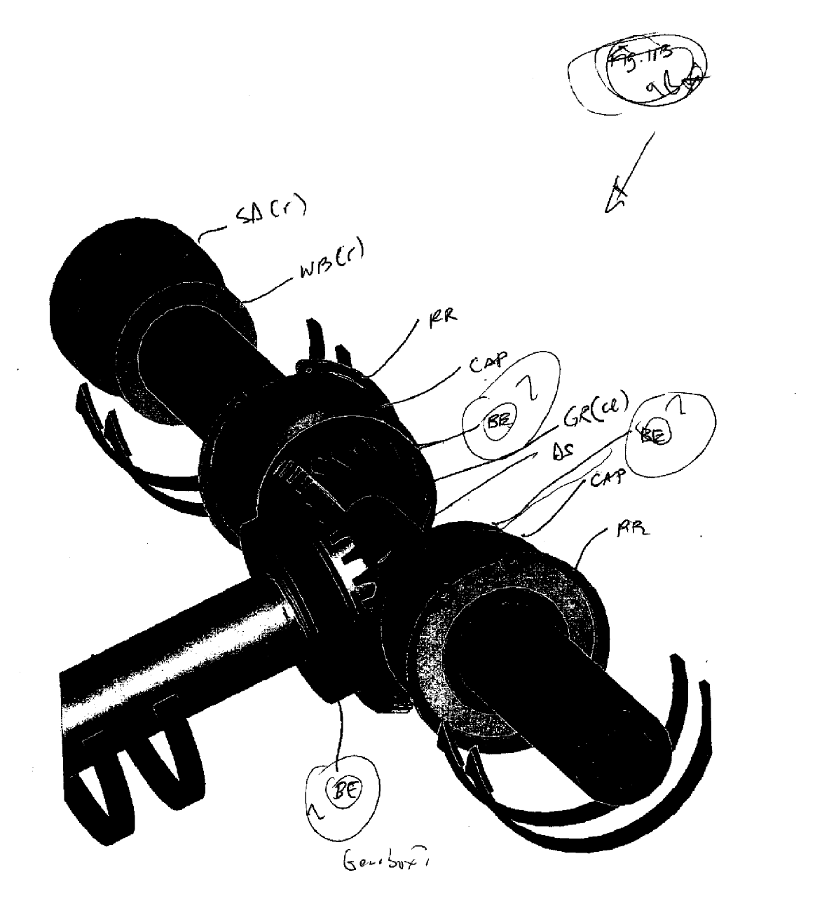

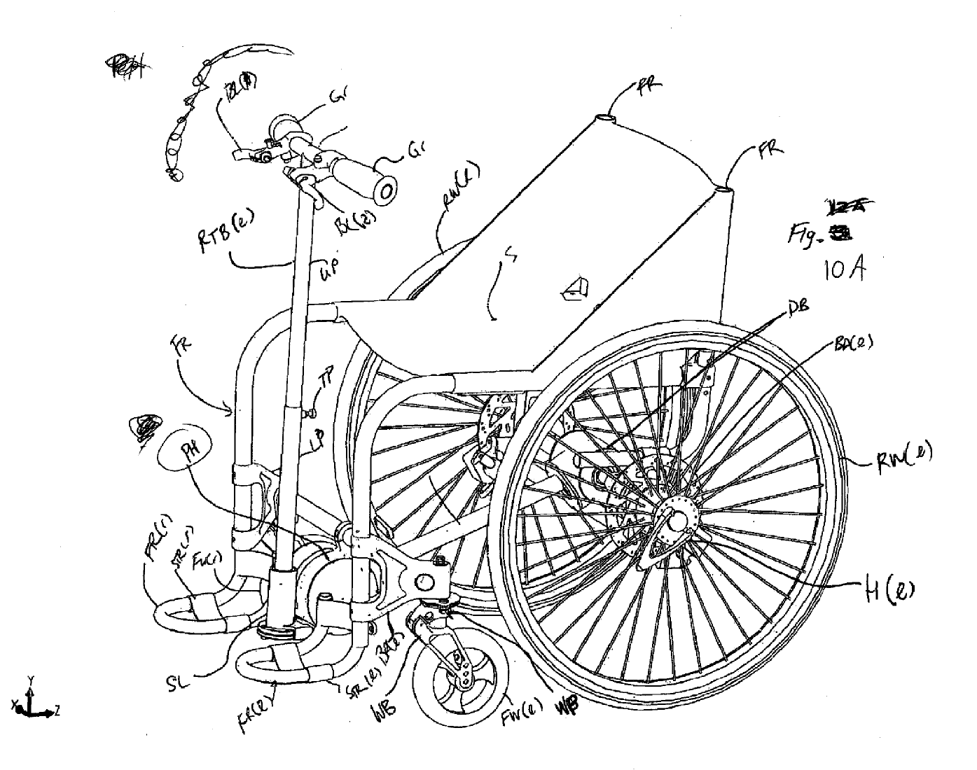

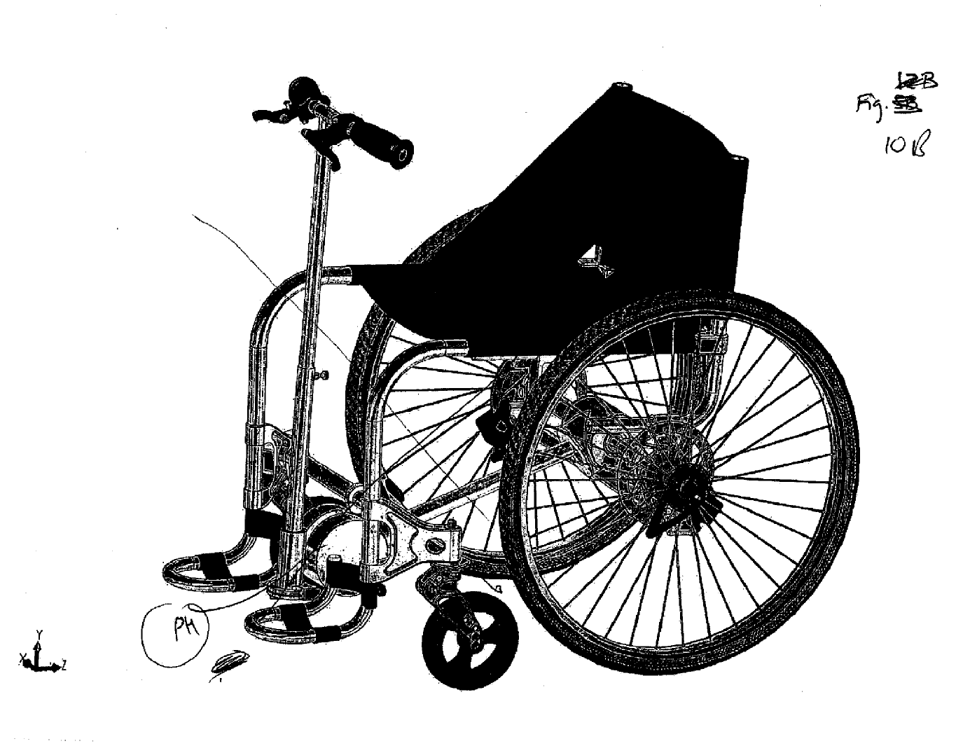

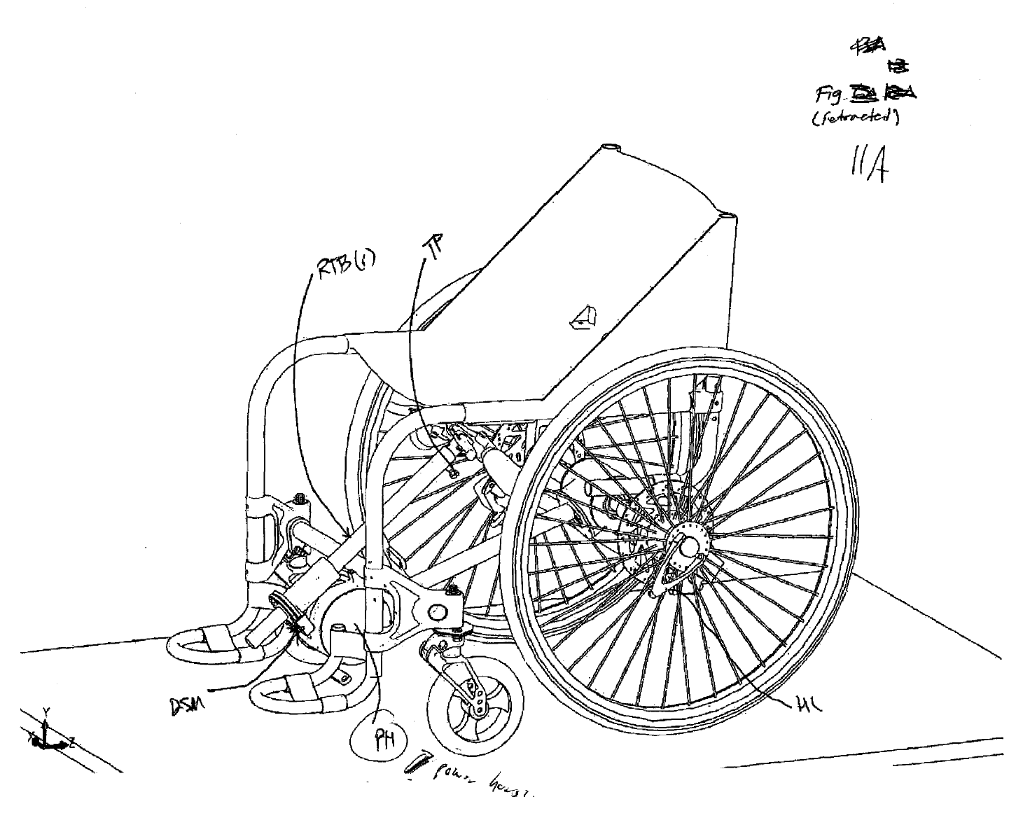

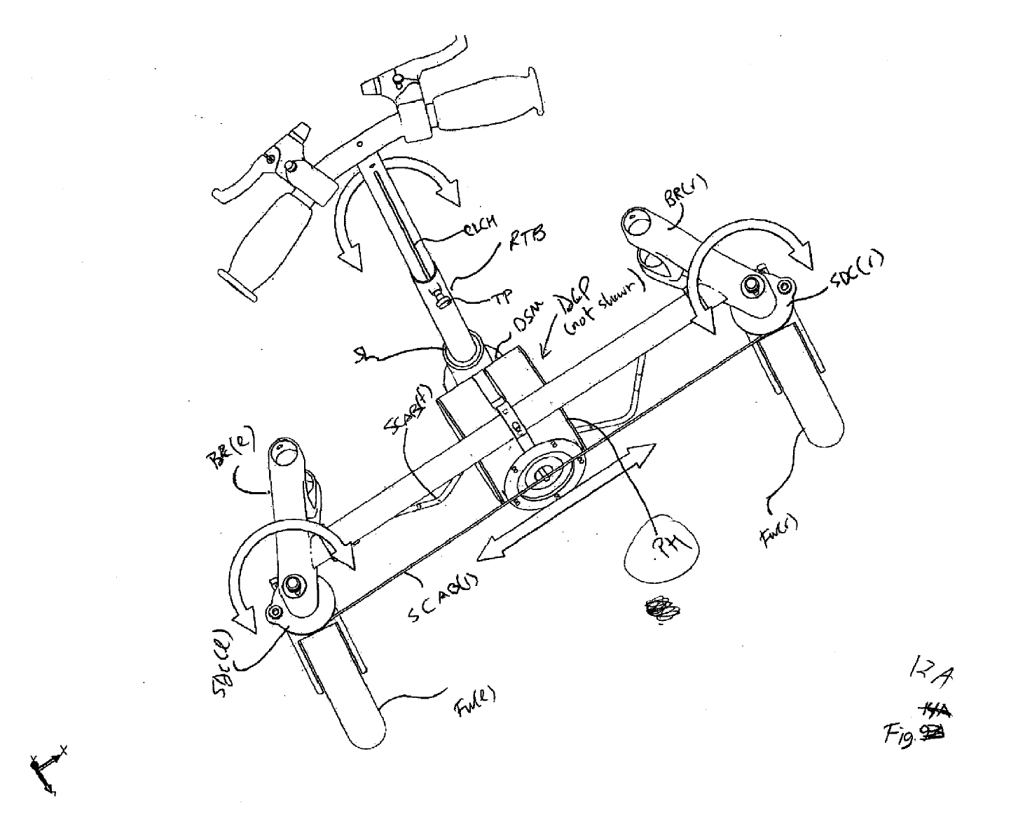

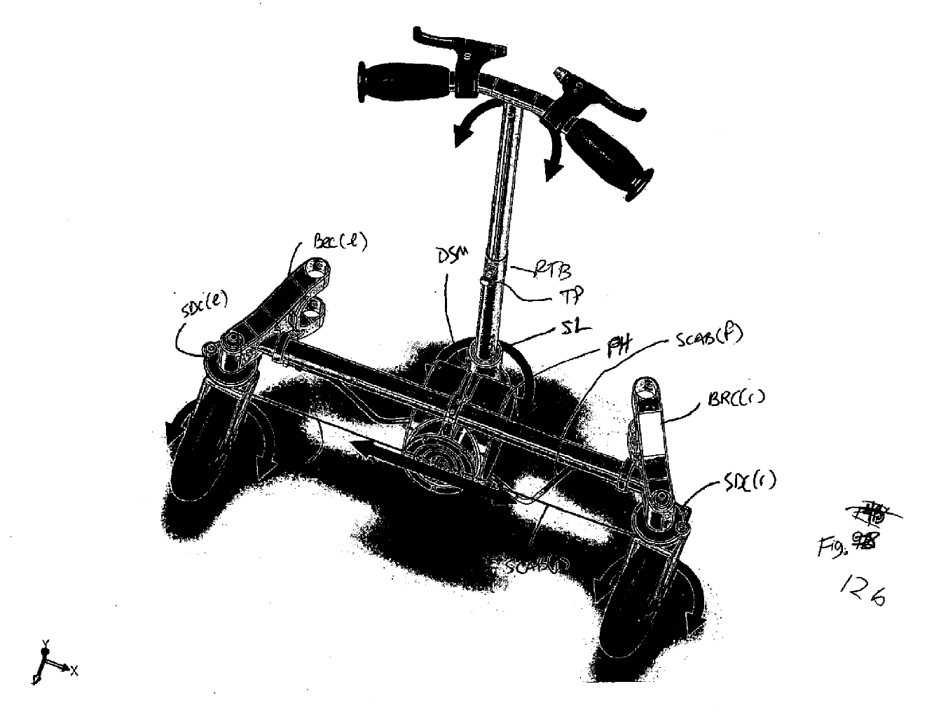

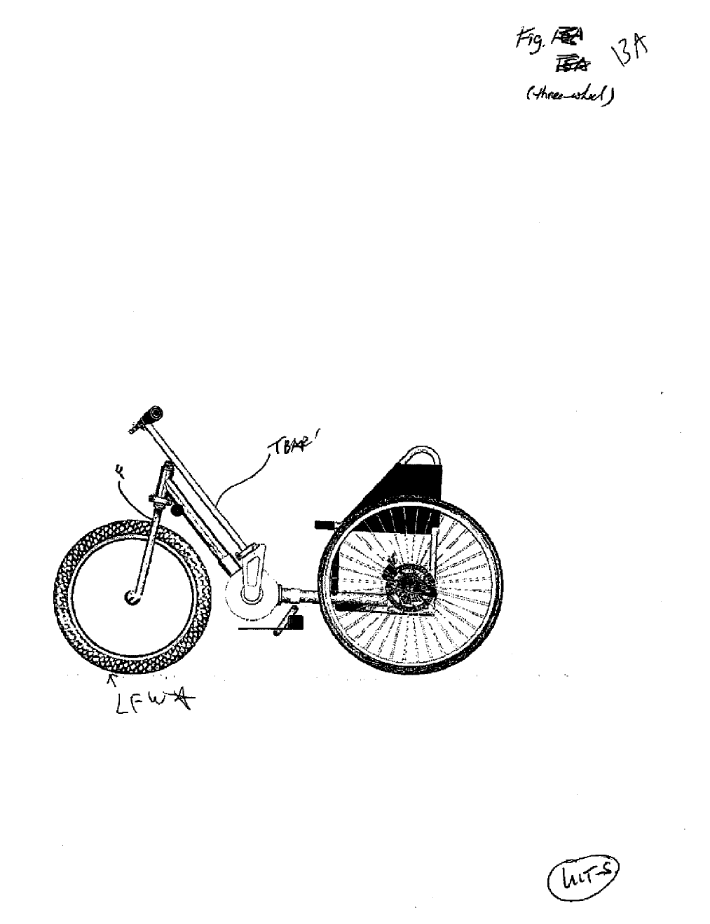

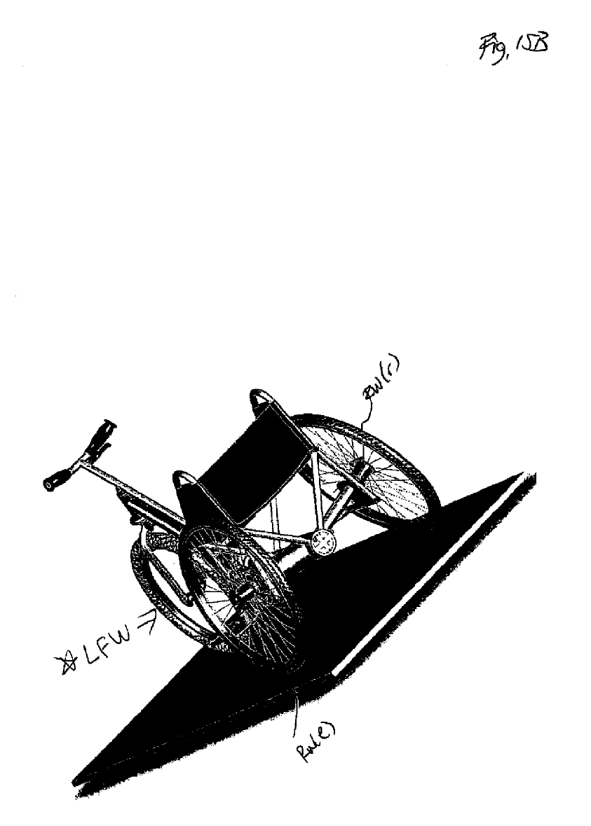

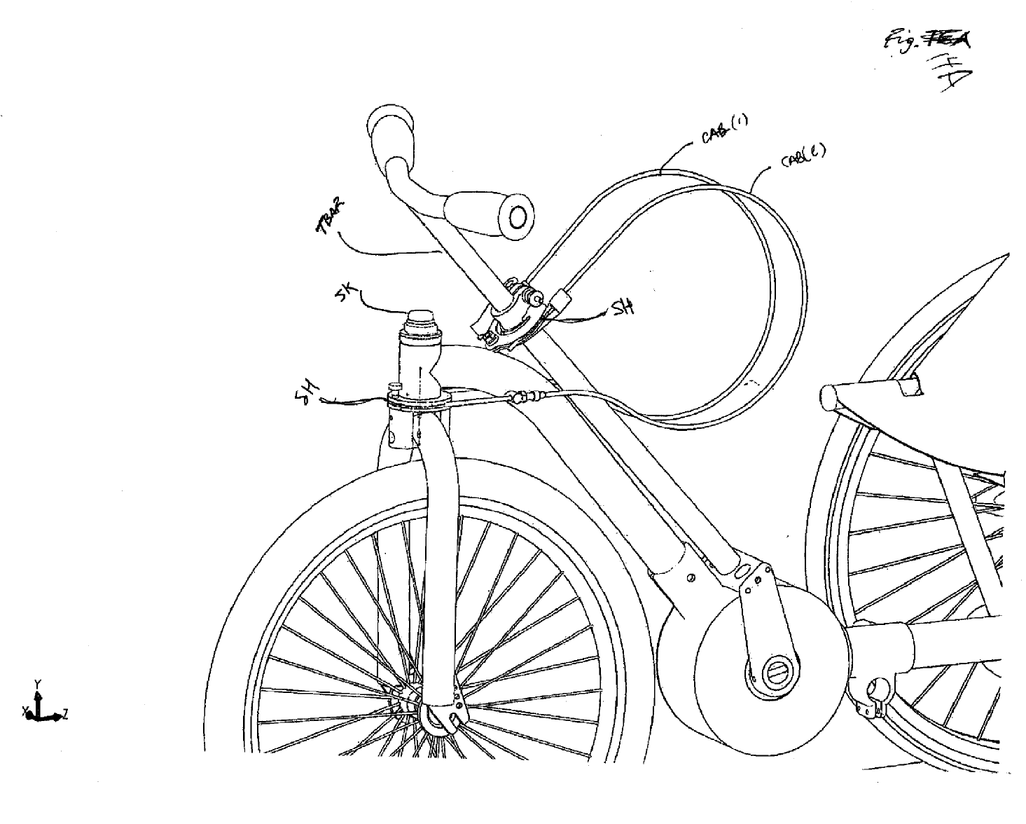

FIGS. 6A-6C shows features of the suspension and support system from the rear view of a first embodiment, including independent rear suspension IRS, differential gearing (see FIGS. 9A/B) 160 for providing power simultaneously and independently and automatically to each of the rear wheels as required, independent drive shafts (See FIGS. 7A/B) DS ×2 for transmitted power to each rear wheel, and roller brakes RB, that are ×2 cable operated from the handle bars and double as parking brakes. Also shown in FIG. 6A are universal joints UJ that are ×2 per drive shaft. FIG. 6B illustrates air shocks AS that are included for a smooth ride, and a feature of the suspension that includes a unique “rising rate” RR to facilitate “fitting” into corners for reduced center of gravity. Referring now to FIG. 6D, a sample of the tilting independent suspension system for each of the rear wheels 510A/B is shown. FIG. 6D is a schematic of how the suspension system allows the rear wheels 510A/B to “tilt” into corners. A sample right turn is shown in FIG. 6D1, as the sample left turn is shown in FIG. 6D2

FIG. 7A shows the differential gears 160a/b that allow the rear wheels of the cycle 510a/b to receive power independently.

FIG. 7B illustrates the differential gears 160a/b from a close-up view.

FIGS. 8A-12B, refer to one a several possible embodiments in which the innovative drive system (and its variations, which are discussed below) used in the above-discussed embodiments, may also be used in a 4-wheel model as well. One of the key features of the alternate embodiments is that they derive power from the system in which the power is derived from motion going in the “forward direction” (away from the rider) and the “backward direction” (towards the rider). In the above illustrative embodiments, this power is derived from gears, however, in the below illustrated embodiments the power is derived from clutches.

FIG. 8A-9B illustrate an alternate version of the power drive (the first type discussed above in FIGS. 5a-5c) (ADS) in which the power to the main axles, AX, of the rear wheels (illustrated below) is derived from motion in both directions (shown as x+ and x−). FIG. 8A illustrates a bi-directional input power drive for both four and five-wheeled models of wheelchairs. A t-bar (collapsible, in the shown and preferred configuration of the illustrated embodiment) RTB(LP) is moved by a user in the forward and reverse directions, such as a rowing motion. The t-bar is held in place by a prop plate PP, and drives the two mitre gears MG(l) and MG(r) being connected through the prop lever connectors PLC(l) and PLC(r). The input shaft IS is rotated to the left and subsequently, right, when the two mitre gears MG(l/r) connect to the locking pin, and drive, the mitre pinion MP.

The drive gear DG, “rotates” alternating clockwise and counter-clockwise (shown by arrows) driving one of the two differential gears GR(co/cl) in the appropriate direction. There are two rotating clutches attached to each of the respective differential gears GR(co/cl), one that rotates only in a clockwise direction RCL(cl) and one the rotates only in a counter clockwise direction RCL(co) which rotate around the differential shaft DS which “rotates” the respective output shaft (see below). Each clutch RCL(cl/co) respectively, will allow the “forward” power from differential gears GR(cl/co) to drive the respective output shafts OS(l) and OS(r) in a “forward direction” allowing a user to derive forward power from both the “away” and “towards” motion on the retractable t-bar RTB(LP).

FIGS. 9A-B illustrate close up details of the “rear” part of the alternate version of the alternate power drive ADS. FIG. 9A shows the basic components without any bearings or covers. The arrows illustrate that the drive gear powers the respective differential gears GR(cl/co) in each respective direction, which drives a respective clutch RCL(cl/co) and the resulting differential shaft DS and output shaft OS(r/l). Thus, the drive gear DG will simply “spin” the clutch RCL(cl/co) when driving in the non-power direction, allowing the “engaged” clutch RCL(cl/co) to power both axles via the output shaft(s) and differential shaft DS. FIG. 9B illustrates the components in an illustrative configuration of the rear part of the power system. Each gear, the drive gear DG, and the two differential gears GE(cl/co) are attached to a bearing (system). The rear clutches are covered by a cap CAP and attached with a retaining ring RR. Also shown is an example of one of the wheel bearings WB(r) and the stub axle SA(r) on the “right” side. A bearing ring BE allows for efficient operation of the drive gear DG and the rear gears and clutch systems. Certain components may be added or subtracted without departing from the scope and spirit of the invention.

As an illustration of the work advantage of the first embodiment of the present invention, the “lever system” is engaged by the rowing motion propulsion arm 110′. In considering the propulsion system 100′, the lever (indexes 110′ and 120′) and gears (see indexes, 130′, 140′ and 150′) ratios may vary from embodiment to embodiment depending on the needs of the end-user, however, in a particular embodiment, given an average riders ability to deliver 50 lbs force at a rate of 44 cycles/min (1 push/pull=1 cycle)×4 ft of lever travel/cycle=176 ft/min. This equates to 50×176=880/ft-pounds/min. For conversion to kilowatts we must multiply 880 ft-pound/min by 0.0000226 which=0.2 kilowatts. (200 W). Given a constant output from the rider of 200 W applied to the mechanical advantage of the Trike's propulsion mechanism we have the following result:—

Mechanical Advantage is defined as MA=L÷E where:—

(L)=load output force; (E)=effort or applied force (l₁)=handle length of the lever above the fulcrum(l₂)=shorter length of the lever below the fulcrum

| | | |
|---|---|---|
| Using the law of levers (I₁) ÷ (I₂) | E × I₁ = | L × I₂ |
| Hence | L ÷ E = | (I₁) ÷ (I₂) |
| Trike Propulsion lever or arms (110) | Leverage = | 20″ ÷ 4″ |
| 20″ (I₁) and 4″ (120) (I₂) | | |
| | MA = | 5:1 |
| Example:- | Applied force = | 50 lbs |
| | (E) | |
| | MA = | 5 |
| | Output force L = | 50 × 5 = |
| | | 250 lbs |

Applying the work rate of 200 W to the alternate Trike propulsion mechanism at a cycle rate of 44/min×the mechanical advantage of 5:1 this yields a constant output sufficient to travel at approx 8 mph (20″ wheel Diameter×π (3.14)=62.8″ circumference×3 for the gear ratio of Large (140) to small sprocket (150)=188″×44 cycles/min=8,290′/min=690ft/min=7.85 mph or approx 2× walking speed.). The above quantitative example is a highly simplified for illustrative purposes and is not intended to limit the present invention. FIGS. 10A and 10B illustrate an illustration of a four-wheel embodiment of the invention using a retractable t-bar system. The embodiment of the four-wheel wheelchair in FIGS. 10A and B is shown in the “up” or “drive” position. The advantage of the embodiment shown in FIGS. 10 A and B (and 11A and B) is that the rotatable (and retractable) T-bar RTB (e) may be ‘collapsed’ and stored under the seat S, when the vehicle is not being operated.

| | |
|---|---|
| A frame FR (which may | Index |
| be made of a single piece or | |
| multiple pieces) provides | |
| support for the seat S and | |
| extends forward turning 90 | |
| degrees down on either side to | |
| the footrest plates FR(r/l). Part | |
| Seat | S |
| Frame | S |
| Front Wheel (left/right) | FW(l/r) |
| Rear Wheel (left/right) | RW(l/r) |
| Retractable T-Bar | RTB(e/r) |
| (extended/retratcted) | UP/LP |
| Upper Portion/Lower Portion | |
| T-Bar Pin | TP |
| Grip | GR |
| Steering Sleeve | SL |
| Foot Rest (left/right) | FW(l/r) |
| Bracket (left/right) | BR(l/r) |
| Wheel Pivot (left/right) | WP(l/r) |
| Wheel Base (left/right) | WB(l/r) |
| Strap (left/right) | STR(l/r) |
| Power Housing | PH |
| Differential Housing | DB |
| Wheel Bracket (left/right) | BR(l/r) |
| Brake Lever (left/right) | BL(l/r) |
| Wheel Hub (left/right) | H(l/r) |
| Brake Discs (left/right) | BD(l/r) |
| Bearing Disc/Ring | BE |

In general the four-wheeled central-drive, retractable power handle embodiment of the invention operates in much the same manner as the above-discussed first embodiment with regard to power.

FIG. 10B is solid model of the alternate embodiment of the invention.

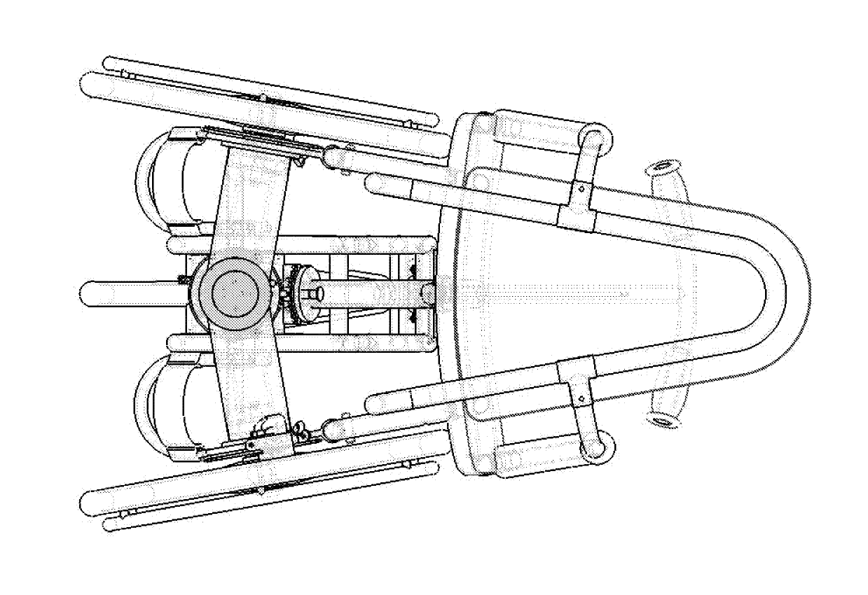

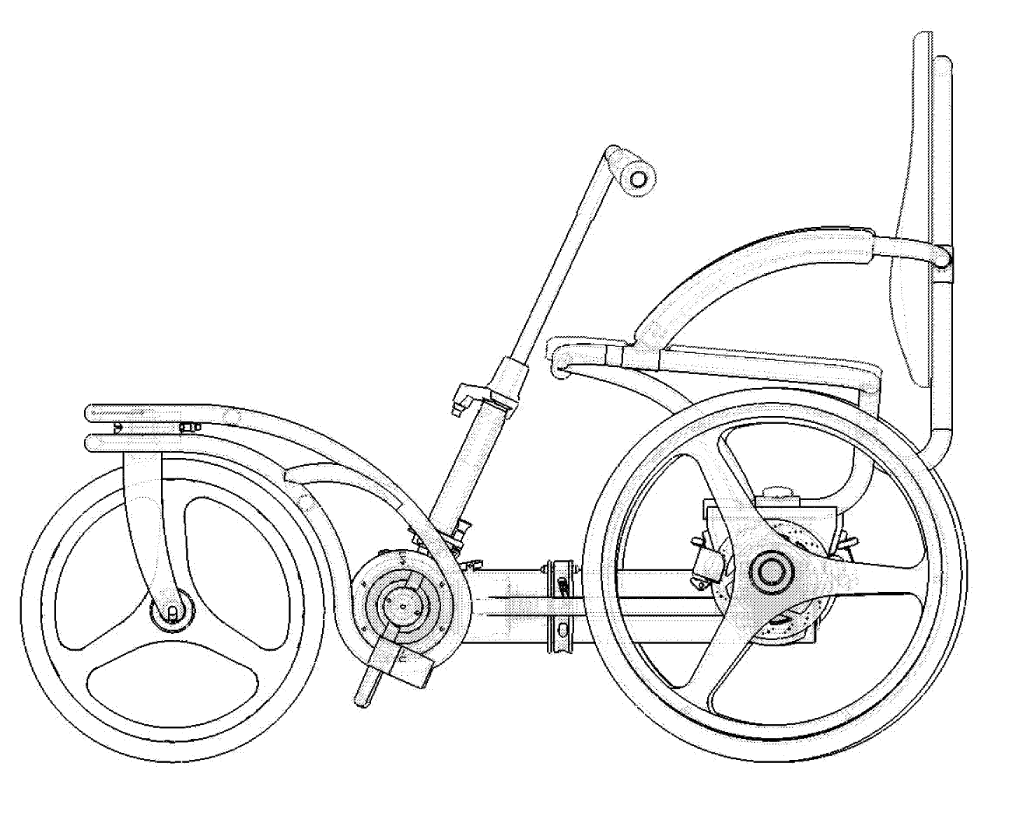

FIGS. 11A and B illustrate the alternate embodiment of the invention with the retractable T-Bar (power lever)RTB (r) in the retracted position, where the pin TP is pulled and the majority of the top portion UP, slides into the hollow portion of the lower portion LP. The retractable T-Bar RTB is then disengaged from the power housing PH and bent into the space under the seat S. This, like the primary embodiment, discussed above, allows a user to operate the wheelchair in a normal fashion, powering the chair by rolling the wheels. FIG. 11B is the retracted power lever RTB (r) in the alternate embodiment shown in a different view. In general, not only is the power lever RTB collapsible, but adjustable as well, so that different arm spans can be accommodated. The collapsible power lever RTB and the power system are generally disengaged from the wheels, by a lever (not illustrated) in the rear of the vehicle. Also the power lever RTB must be disengaged from the steering system for the front wheels FW(I/r), so that the power lever RTB may be easily stowed under the seat S without movement when the chair turns. A pin (not illustrated) allows the power lever RTB to be disengaged. But a latch or lever may be used as well.

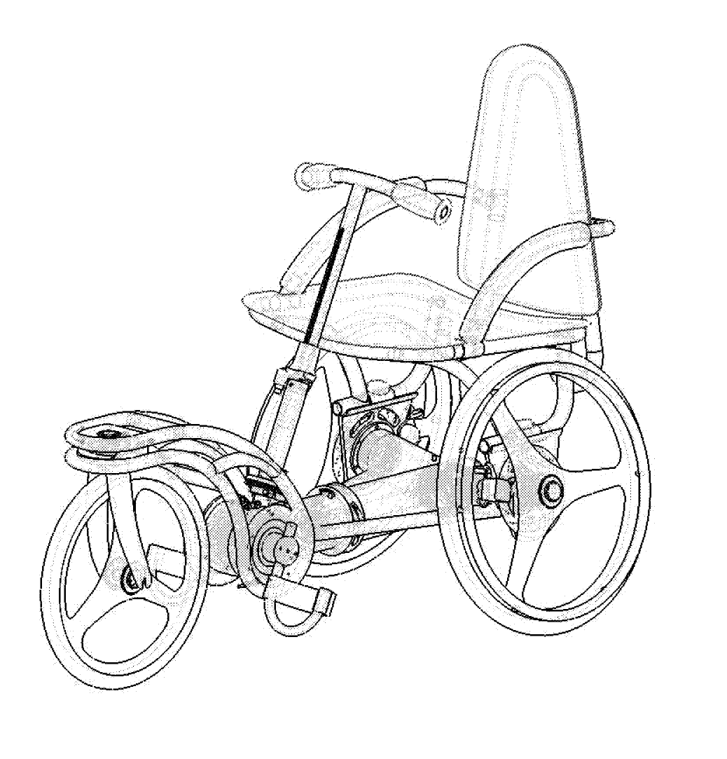

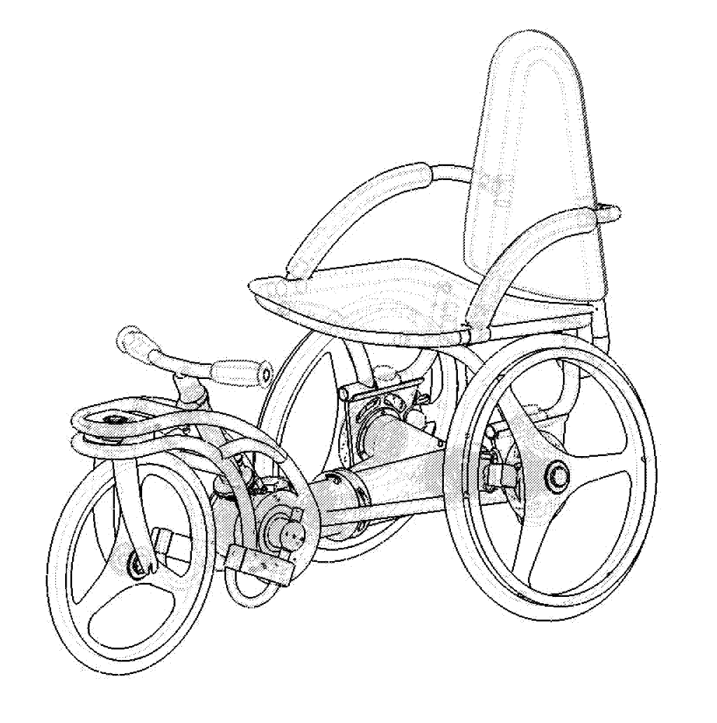

FIGS. 12A and B illustrate the detail of a particular configuration of the steering system in the four wheel embodiment. The retractable T-Bar (power lever) RTB rotates in a (bearing) sleeve SL, such that the rotation will not disrupt the generation of power to the gears in the power housing PH, while the user is moving the power lever RTB in a rowing motion. The steering mechanism DSM allows the turning of the power lever RTB to operate the steering cable SCAB, which has two portions, a front portion SCAB(f) and a rear portion SCAB(r), each of which operate the steering discs SDC(l/r) or steering halos located at, and bolted to, the top of the wheel pivot WP(l/r). When the steering column DSM is disengaged because the power lever RTB is collapsed and/or moved under the seating area, the steering mechanism DSM is also disconnected from the power lever RTB so that the power lever RTB may be easily stowed under the seat S without movement when the chair turns.

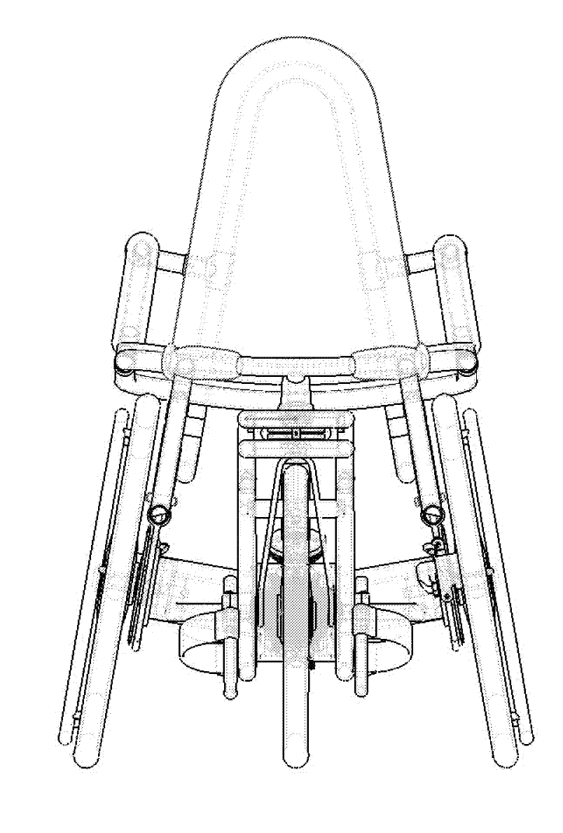

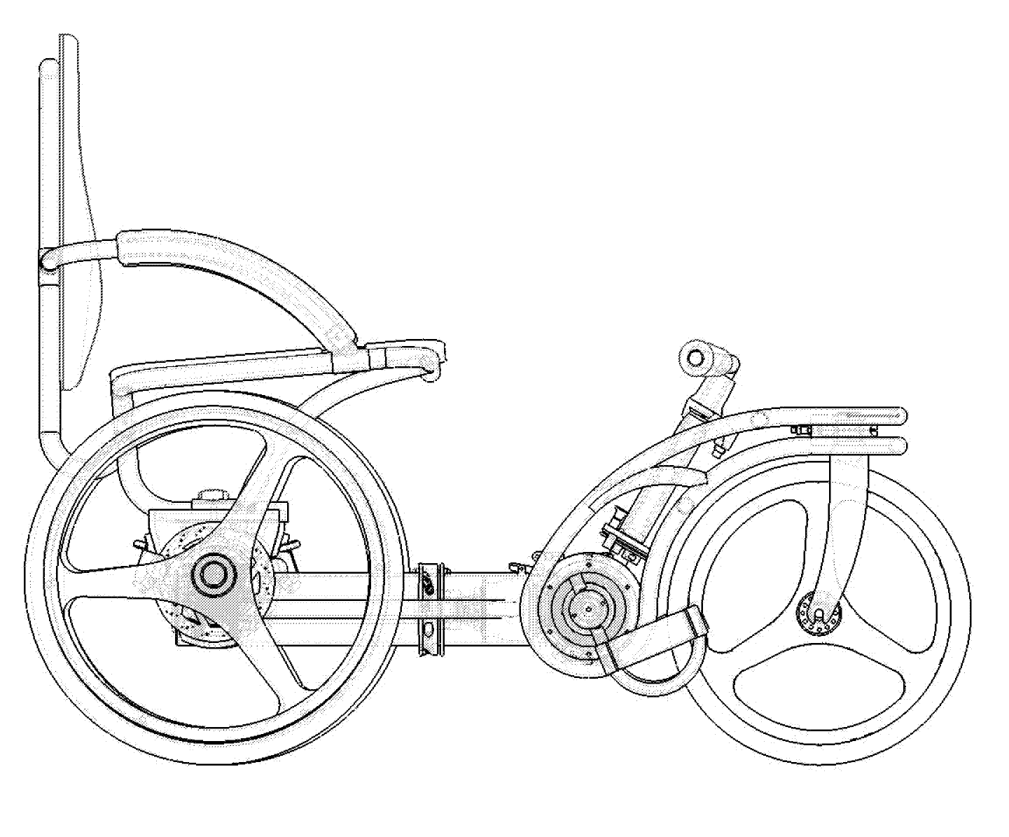

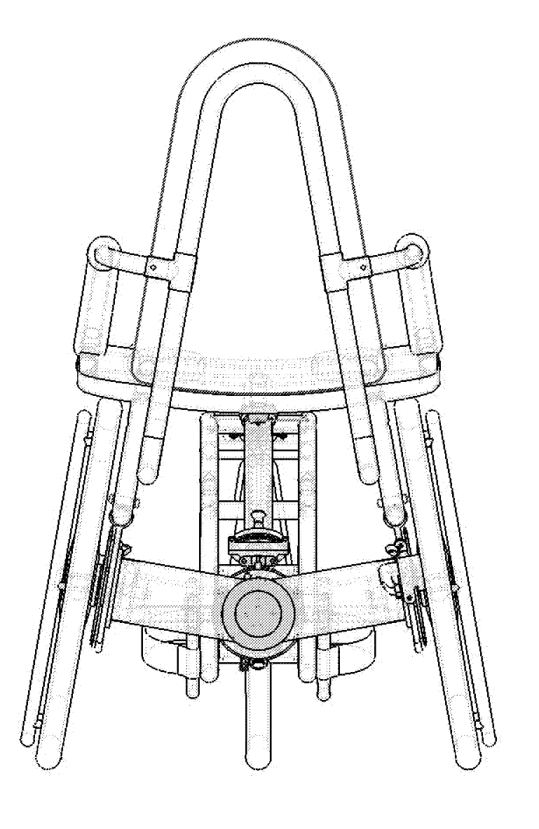

FIG. 13A and B illustrate yet another alternate version (“second alternate embodiment”) of the rowing-motion propelled vehicle. In the second alternate embodiment, the two small front wheels FW (l/r) of the four wheel embodiment are replaced by a larger (usually around 45-55 cm) front wheel LFW. The jockey wheels, as illustrated in the first embodiment, may be included, but are not in the example. In general, there is less of an advantage of having a collapsible power lever, but it may still be desirable based on the needs of the end user. The wheel base of the second alternate (three wheeled) or first (five-wheeled) embodiment is much greater than the alternate embodiment (four wheeled) shown above.

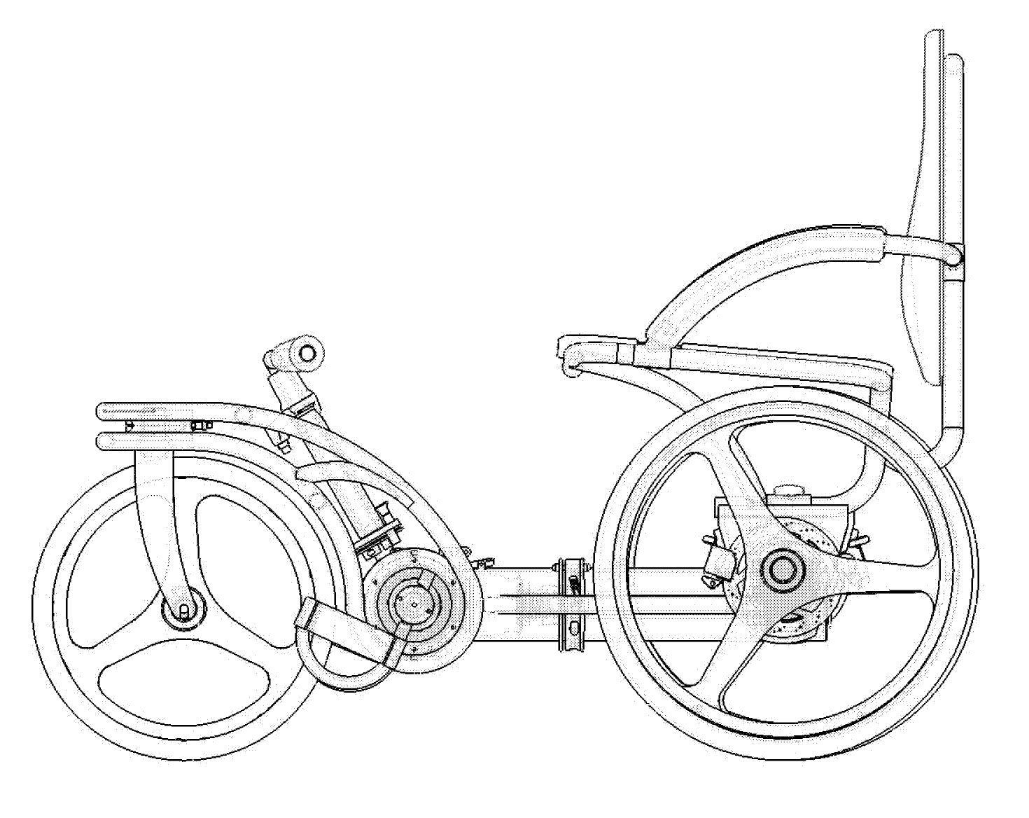

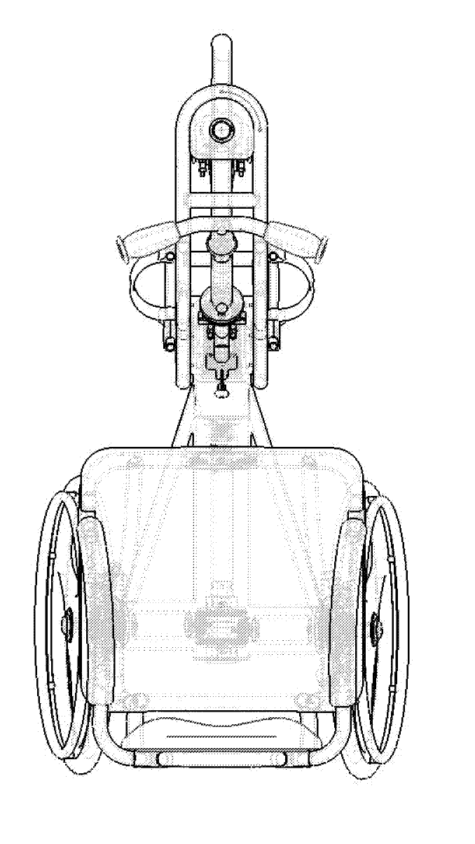

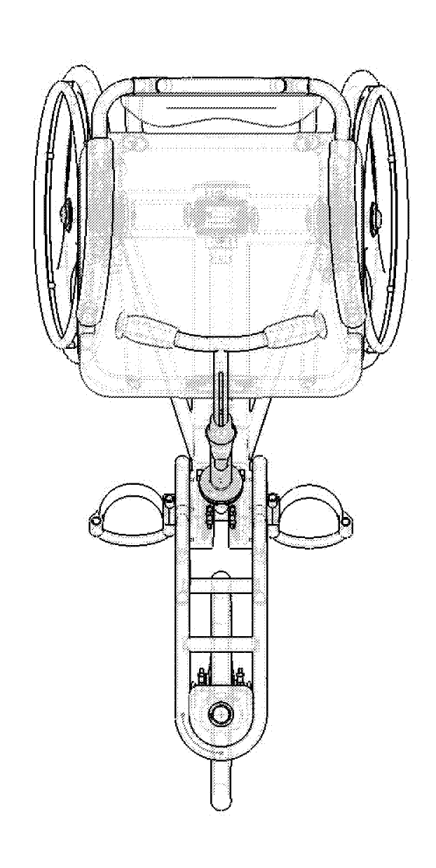

FIGS. 14A and B illustrate the steering system of the second alternate version of rowing motion propelled vehicle. In general, the steering works by turning the handlebars, just like a bicycle. A Halo SH is affixed at the top of the forks and a similar one on the propulsion lever SH. A continuous cable loop CAB clamped into the halo SH at each end is pulled according to which way the handle bar RTB(u) is turned, causing the forks F to turn accordingly. The cable CAB has tensioners on each side to set the tracking and keep it taught. The loop in the cables allows the power lever TBAR to be pushed/pulled back and forth, just like the brake cables are looped to allow the handlebars to turn on a bicycle. There is a spring loaded plunger pin on the fork halo to disengage the cable so the front wheel can behave just like a jockey wheel when the Trike/Wheelchair is propelled with the pushrims. As a matter of less significance the turn ratio is governed by the relative size of the halos, typically they are equal giving a 1:1 ratio. The particular steering system may be used with the first embodiment discussed above in FIGS. 2A-7B, without altering the design.

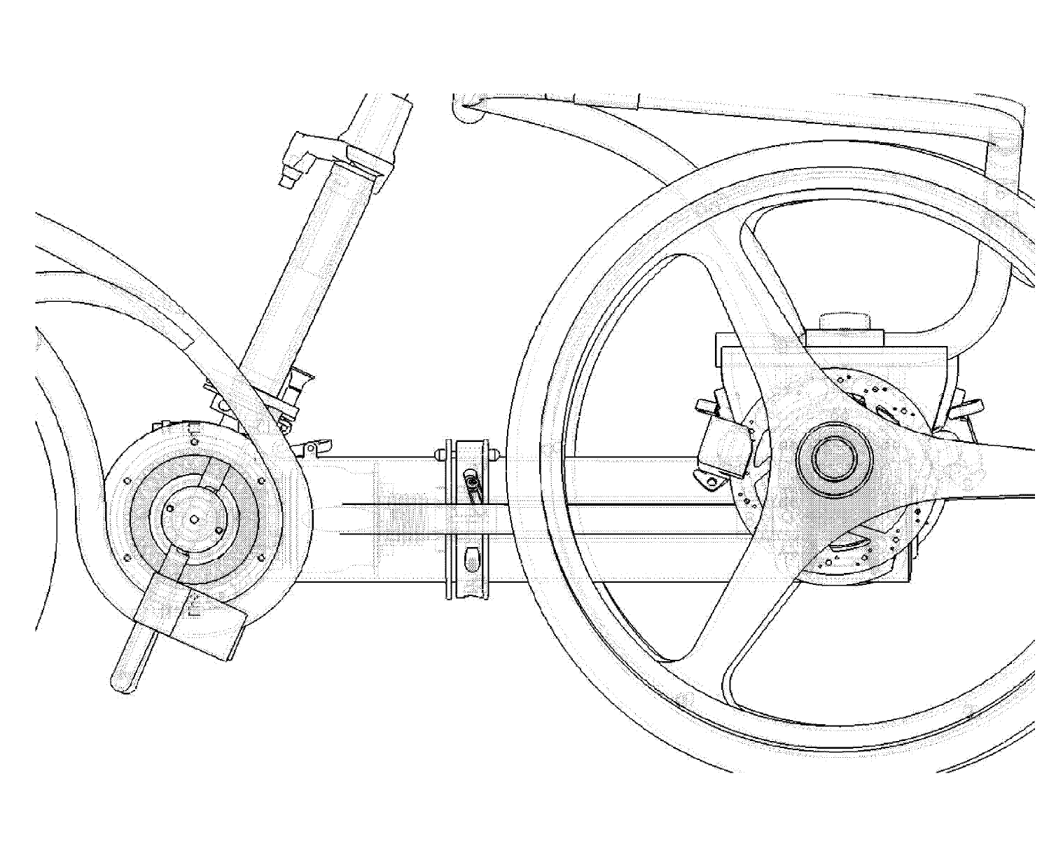

FIGS. 15A-J are illustrations of the details of a second alternate embodiment of the invention. Many of the details are discussed in the above in FIGS. 8-14. However, the second alternate embodiment is not meant to limit the invention and is for illustrative purposes only. Although the same principles are used in many of the components, there may be small variations in detail.

I claim:

1. A rowing-motion propelled vehicle comprising:
a frame comprising at least two portions, a first portion for supporting an seat and a second portion for supporting footrest structures and structurally connected to a rear axle, said rear axle connected to two rear wheels, said second portion of said frame supporting at least two front wheels;
said rotatable propulsion lever connected to a cable that steers said at least two front wheels;
a power drive system including: a rotatable collapsible propulsion lever capable of moving in the forward and reverse arced direction, said propulsion lever connected to and moving a forward gear in the forward and reverse direction, said forward gear turning an input axle alternatingly in clockwise and counterclockwise rotation, said input axle attached at a rear end to a drive gear , said drive gear meshed and driving two differential gears configured facing each other and each of said differential gears attached to a clutch and an output shaft, said clutches allowing said respective differential gears to move said respective output shaft only forward, said respective output shafts driving said two rear wheels,
whereby power is derived from both a forward and reverse motion of said collapsible propulsion lever.

2. The vehicle as recited in claim 1, further including a differential shaft connecting said two differential gears and said two clutches.

3. The vehicle as recited in claim 2, wherein said power system is disengaged from said two rear wheels by a release.

4. The vehicle as recited in claim 3, wherein said collapsible propulsion lever includes a pin, and when collapsed is folded back under a seat.

5. The hand-propelled vehicle as recited in claim 3, further including a braking system, said braking system including a brake handle on said lever, said brake handle operating a brake cable, for operating a brake for braking said rear wheels.

6. A motion-propelled wheelchair in which a power drive system derives power from a foldable propulsion lever, said foldable propulsion lever capable of generating forward power moving both away from and towards the frame;
said foldable propulsion lever turnable and connected to a set of front wheels through a steering cable.

7. The motion-propelled vehicle as recited in claim 6, wherein said foldable propulsion lever drives a drive axle, said drive axle moving in both the clockwise and counterclockwise direction.

8. The motion-propelled vehicle as recited in claim 7, wherein said drive axle is connected to a drive gear that moves in the same direction as said drive axle, said drive gear driving an opposed set of gear and clutch combinations located on said rear axle.

9. The motion-propelled vehicle as recited in claim 8, wherein when said drive gear rotates in a first direction, said drive gear engages one of said set of gears on said rear axle and one of said set of clutches on said rear axle, such that the rear axle is rotated in the forward direction, and when said drive gear moves in the opposite to said first direction, said drive gear engages the opposite of said one of said set of gears on said rear axle, and the opposite of said one of said set of clutches, such that the rear axle is rotated in the forward direction.

10. The motion-propelled vehicle as recited in claim 7, wherein said foldable propulsion lever folds downward in a cylinder-in-cylinder configuration and then said folder propulsion lever can be folded under a seat.

11. The motion-propelled vehicle as recited in claim 10, wherein when said foldable propulsion lever is folded under said set, a set of rear wheels are disconnected from said drive axle.

12. The motion-propelled vehicle as recited in claim 7, wherein said foldable propulsion lever includes a brake handle, said brake handle contracting a cable that is connected to a pair of brakes located on said rear axle.

13. A motion-propelled vehicle for a seated rider, comprising:
a set of rear wheels connected to an axle;
a set of front wheels;
an upper frame holding a seat;
a lower frame supporting a power system and comprised of a rear axle and rear wheels;
said upper frame connected to said lower frame above said rear wheels and at a set of brackets for said front wheels;
said power system including a propulsion lever capable of moving forwards, away from said seat and backwards towards said seat in a rowing motion, said propulsion lever connected to a front gear rotating an drive axle in both a clockwise and counter-clockwise motion and said drive axle connected to said rear axle via a set of gears and clutches; and
said drive axle propelling said vehicle forward by turning in either direction.

14. The vehicle as recited in claim 13, wherein said propulsion handle can be folded by operation of a pin, and then placed underneath said seat.

15. The vehicle as recited in claim 14, wherein said rear wheels are disengaged from said power system when said propulsion handle is folded underneath said seat.

16. The vehicle as recited in claim 14, wherein said propulsion lever is constructed in a cylinder-in-cylinder configuration and an upper portion rotates at least 180 degrees and is connected at a bottom portion to a steering cable connected to a steering system for said front wheels.

17. The vehicle as recited in claim 16, further including at least one brake lever on said upper portion of said propulsion lever, said at least one brake lever operating a brake cable connected to a set of brakes located on said rear axle.

18. The vehicle as recited in claim 14, further including a pair of footrests formed into said upper frame at a lower portion extending downward from said seat and extending outward for foot placement.
